(19) United States
(12) Patent Application Publication
(10) Pub. No.: US 2023/0210063 A1
(43) Pub. Date: Jul. 6, 2023

(54) MULTI-STAGE PLANT CULTIVATION SYSTEM FOR AND METHOD OF ENHANCING PLANT PRODUCTION EFFICIENCY

(71) Applicant: Renquist Mica, Brighton, CO (US)

(72) Inventor: Renquist Mica, Brighton, CO (US)

(21) Appl. No.: 18/000,170

(22) PCT Filed: Jun. 1, 2021
(86) PCT No.: PCT/US2021/035259

§ 371 Date: Nov. 29, 2022

Related U.S. Application Data
(60) Provisional application No. 63/032,360, filed on May 29, 2020.

(51) Int. Cl. A01G 9/26; A01G 9/24; A01G 22/00; A01G 9/18

(52) U.S. Cl. CPC A01G 9/26; A01G 9/246; A01G 9/247; A01G 9/249; A01G 22/00; A01G 9/18

(57) ABSTRACT

A multi-stage plant cultivation system for and method of enhancing plant production efficiency is disclosed. For example, a multi-stage plant cultivation system and method may provide a vegetation module and multiple growing modules arranged sequentially and wherein the full growing life cycle of a plant may be perform within the modules. In one example, the multi-stage plant cultivation system and method may provide a vegetation module and multiple growing modules that may further include a plant transport system, one or more air handler systems, one or more lighting systems, one or more water delivery systems, one or more wastewater systems, and a controller.

### CROSS-REFERENCE TO RELATED APPLICATIONS

The present invention is a U.S. National Phase Patent Application based on PCT International Patent App. No. PCT/US21/35259, entitled “A Multi-stage Cultivation System for Enhancing Plant Production Efficiency,” filed Jun. 1, 2021, which claims the benefit of U.S. Provisional Patent App. No. 63/032,360, entitled “A Multi-stage Cultivation System for Enhancing Plant Production Efficiency,” filed on May 29, 2020; the entire disclosures of which are incorporated herein by reference.

### TECHNICAL FIELD

The subject matter of the present invention relates generally to plant cultivation processes and more particularly to a multi-stage plant cultivation system for and method of enhancing plant production efficiency.

### BACKGROUND

Current plant cultivation systems offer compartmentalized processes with respect to the full growing life cycle of a plant. However, the processes of current plant cultivation systems introduce inefficiencies in the overall methodologies that address the full growing life cycle of a plant. For example, there are great inefficiencies with respect to the workflow, logistics, and manpower related to cultivating plants from the vegetation phase, all the way through to the flowering and harvesting phases. For example, current workflow processes include segmented or disjointed operating procedures. Further, current plant cultivation systems and processes can be highly energy inefficient.

Accordingly, there is a need for improved plant cultivation systems and methods for enhancing plant production efficiency.

### SUMMARY

To address the foregoing problems, in whole or in part, and/or other problems that may have been observed by persons skilled in the art, the present disclosure provides compositions and methods as described by way of example as set forth below.

In one aspect, a multi-stage plant cultivation system for enhancing plant production efficiency through the full growing life cycle of a plant is provided, comprising: a) one or more vegetation modules; and b) one or more growing modules capable of being tailored with respect to plant growing phases and harvesting; wherein the vegetation module and the multiple growing modules are arranged sequentially and wherein the full growing life cycle of a plant may be performed within the modules. In a further aspect, the one or more vegetation modules are configured for a germination phase, a seedling phase, and/or a vegetative phase of the plants. In another aspect, the one or more growing modules are configured for one or more flowering phases of the plants. In a further aspect, the one or more vegetation modules and the one or more growing modules are arranged sequentially.

In some aspects, the multi-stage plant cultivation system comprises the following modules in the following order: a vegetation module, a first growing module, a second growing module, a third growing module, and a fourth growing module. In particular aspects, the first growing module is configured for a first-stage flowering phase of the plants, the second growing module is configured for a second-stage flowering phase of the plants, the third growing module is configured for a third-stage flowering phase of the plants, and the fourth growing module is configured for a fourth-stage flowering phase of the plants.

In other aspects, the multi-stage plant cultivation system further comprises one or more additional components selected from the group consisting of a plant transport system, one or more air handler systems, one or more lighting systems, one or more water delivery systems, one or more wastewater systems, and a controller.

In one aspect, the transport system is capable of automatically translating or moving some number of plants along the multi-stage plant cultivation system. In another aspect the transport system is a common transport system for moving plants from one module to another and comprises a conveyor belt system, a gravity-based roller system, a motorized roller system, a gravity-based rail system, or a motorized rail system.

In one aspect, the one or more air handler systems comprise air handler systems for supporting growing environments in the one or more vegetation modules and/or the one or more growing modules. In another aspect, the one or more air handler systems support the one or more vegetation modules. In another aspect, the one or more air handler systems support the one or more growing modules.

In one aspect, the one or more lighting systems are suitable for growing plants and comprise light-emitting diodes (LED) white light sources or florescent white light sources. In another aspect, the one or more lighting systems support the one or more vegetation modules. In another aspect, the one or more lighting systems support the one or more growing modules.

In one aspect, the one or more water delivery systems are suitable for growing plants and comprise one or more water supply lines, one or more sprinkler heads, one or more spray heads, one or more water spikes, and/or one or more flood systems. In another aspect, the one or more water delivery support the one or more vegetation modules. In another aspect, the one or more water delivery systems support the one or more growing modules. In further aspects, the one or more water delivery systems comprise a water supply line to each module. In still further aspects, the one or more water delivery systems comprise individual water storage tanks above each module configured to hold an amount of water that is tailored for each growth stage. In additional aspects, the water further comprises one or more nutrients tailored for each growth stage.

In one aspect, the one or more wastewater removal systems are suitable for growing plants. In another aspect, the one or more wastewater removal systems support the one or more vegetation modules. In another aspect, the one or more wastewater removal systems support the one or more growing modules. In a further aspect, the one or more wastewater removal systems support both the one or more vegetation modules and the one or more growing modules.

In one aspect, the controller comprises a microcontroller device, a microprocessor device, and/or a computing device. In another aspect, the controller comprises a centralized server, a cloud server, a desktop computer, a laptop computer, a handheld computing device, a mobile phone or smart phone, a tablet device, and/or a smartwatch.

In another aspect, the multi-stage plant cultivation system further comprises a certain amount of data storage associated with the controller. In some aspects, the controller is a networked computing device accessible via a network, particularly wherein the network comprises a local area network (LAN) and/or a wide area network (WAN) for connecting to the Internet or to an Intranet.

In a further aspect, the multi-stage plant cultivation system further comprises granular automation configured to track plant-specific data at each stage via video in order to reduce the human interaction required at each stage, wherein plant-specific data comprises temperature, humidity, soil moisture, plant height, and/or CO₂ levels.

In another aspect, the multi-stage plant cultivation system is for cultivating cannabis plants.

In a further aspect, the one or more vegetation modules are configured to provide a controlled environment in which the plants may grow for some period of time, such as about two weeks. In other aspects, the one or more vegetation modules are configured to be controlled with respect to light, airflow, humidity, temperature, water delivery, and/or wastewater removal for the type of plant being grown.

In a further aspect, the one or more growing modules are configured to provide a controlled environment in which the plants may grow for some period of time, such as about two weeks. In other aspects, the one or more growing modules are configured to be controlled with respect to light, airflow, humidity, temperature, water delivery, and/or wastewater removal for the type of plant being grown.

In some aspects, the one or more vegetation modules and the one or more growing modules are arranged in a line atop an undercarriage. In other aspects, the undercarriage comprises a roller transport system that spans the full distance of all the modules. In further aspects, a portion of the roller transport system spans the widths of the one or more vegetation modules. In further aspects, the undercarriage is a fixed undercarriage. In still further aspects, the undercarriage is a mobile undercarriage configured to allow the plant cultivation system to be moved.

In other aspects, the multi-stage plant cultivation system further comprises one or more grow trays configured to hold plants and sit atop the roller transport system. In additional aspects, the grow trays are further configured to be moved from one module to another by rolling atop the roller transport system.

In still further aspects, the multi-stage plant cultivation system further comprises one or more wastewater drain gutters provided along the undercarriage. In another aspect, the one or more wastewater drain gutters are configured to channel wastewater to be recycled or disposed of according to water codes.

In other aspects, the multi-stage plant cultivation system further comprises one or more water supply lines provided along the undercarriage configured to supply water to the one or more vegetation modules and/or the one or more growing modules.

In additional aspects, at least a portion of the one or more wastewater drain gutters and one or more water supply lines extend to the one or more vegetation modules via the undercarriage.

In another aspect, the one or more vegetation modules each comprise a front access door and a side exit door. In one aspect, the front access door spans substantially the full width and height of the one or more vegetation modules. In another aspect, the side exit door spans substantially the full depth and partial height of the one or more vegetation modules. In further aspects, the front access door and the side exit door comprise rollup type doors suitable to maintain airtight and light-tight conditions within the one or more vegetation modules, particularly wherein the rollup type doors comprise aluminum or plastic slats configured to slide together to provide a light-tight and airtight seal. In additional aspects, the front access door and the side exit door further comprise seals comprising a thermoplastic elastomer or polyurethane.

In further aspects, the multi-stage plant cultivation system further comprises one or more grow lights provided inside the one or more vegetation modules, particularly wherein the one or more grow lights comprise LED lights and/or florescent lights.

In further aspects, the multi-stage plant cultivation system further comprises one or more air handler units provided in the one or more vegetation modules, particularly wherein the one or more air handler units comprise heating, ventilation, and air conditioning (HVAC) units and/or are configured to pull in fresh air from the surrounding environment. In another aspect, the one or more air handler units comprise a controller.

In other aspects, the one or more growing modules comprise a substantially open metal frame structure. In further aspects, at least one of the one or more growing modules comprise an enclosed or partially enclosed metal frame structure.

In further aspects, the multi-stage plant cultivation system further comprises one or more grow lights provided inside the one or more growing modules, particularly wherein the one or more grow lights comprise LED lights and/or florescent lights.

In additional aspects, a portion of the roller transport system spans the widths of the one or more growing modules.

In other aspects, the multi-stage plant cultivation system further comprises one or more air handler units provided in the one or more growing modules, particularly wherein the one or more air handler units comprise heating, ventilation, and air conditioning (HVAC) units and/or are configured to pull in fresh air from the surrounding environment. In another aspect, the one or more air handler units comprise a controller.

In still further aspects, the roller transport system, the one or more wastewater drain gutters, and the one or more water supply lines each span the entire length of the one or more vegetation modules and the one or more growing modules via the undercarriage.

In another aspect, the one or more grow trays are further configured to allow for loading and unloading using a forklift.

In a further aspect, the roller transport system comprises an incline.

In other aspects, the multi-stage plant cultivation system is configured to allow independent control of each of the one or more vegetation modules and the one or more growing modules with respect to time, light, airflow, humidity, temperature, water delivery, and/or wastewater removal.

In still further aspects, a method for enhancing plant production efficiency is provided, comprising performing the full growing life cycle of the plant within the modules of the multi-stage plant cultivation system described above.

In some aspects, the method for enhancing plant production efficiency comprises: i) processing a batch of plants in the one or more vegetation modules for a certain amount of time; ii) advancing the batch of plants to the one or more growing modules for a certain amount of time; and iii) removing the batch of plants from the multi-stage plant cultivation system. In additional aspects, step ii) comprises: iia) advancing the batch of plants to a first growing module and processing the batch of plants for a certain amount of time; iib) advancing the batch of plants to a second growing module and processing the batch of plants for a certain amount of time; iic) advancing the batch of plants to a third growing module and processing the batch of plants for a certain amount of time; and iid) advancing the batch of plants to a fourth growing module and processing the batch of plants for a certain amount of time.

In some aspects, the method for enhancing plant production efficiency comprises: i) providing the multi-stage plant cultivation system; ii) activating the multi-stage plant cultivation system; iii) loading the plants into the one or more vegetation modules; iv) performing germination, seedling, and/or vegetative growing phases of the plants within the one or more vegetation modules for a certain amount of time; v) moving the plants out of the one or more vegetation modules and into the one or more growing modules for a certain amount of time; and vi) removing the batch of plants from the multi-stage plant cultivation system. In additional aspects, step v) comprises: va) moving the plants to a first growing module and processing the plants for a certain amount of time; vb) moving the plants to a second growing module and processing the plants for a certain amount of time; vc) advancing the plants to a third growing module and processing the plants for a certain amount of time; and vd) advancing the plants to a fourth growing module and processing the plants for a certain amount of time.

In further aspects, after removal of the batch of plants from the multi-stage plant cultivation system, the method comprises advancing the batch of plants to downstream harvesting processes.

In other aspects, the method comprises processing multiple batches of plants in different modules simultaneously.

In further aspects, the plant within the methods of the invention is a cannabis plant.

In still further aspects, the multi-stage plant cultivation system is configured to be stackable.

Additional features of the invention will be or will become apparent to one with skill in the art upon examination of the following figures and detailed description. It is intended that all such additional features and advantages be included within this description, be within the scope of the invention, and be protected by the accompanying claims.

### BRIEF DESCRIPTION OF THE DRAWINGS

Having thus described the subject matter of the present invention in general terms, reference will now be made to the accompanying drawings, which are not necessarily drawn to scale, and wherein:

FIG. 1 illustrates a block diagram of an example of a multi-stage plant cultivation system for enhancing plant production efficiency, in accordance with an embodiment of the invention;

FIG. 2, FIG. 3, and FIG. 4 illustrate perspective views of an example of one instance of the multi-stage plant cultivation system shown in FIG. 1, in accordance with an embodiment of the invention;

FIG. 5 and FIG. 6 illustrate perspective views of a vegetation module portion of the multi-stage plant cultivation system shown in FIG. 2, FIG. 3, and FIG. 4 and wherein the door of the vegetation module is open and closed, respectively;

FIG. 7 and FIG. 8 illustrate end views of the multi-stage plant cultivation system shown in FIG. 2, FIG. 3, and FIG. 4;

FIG. 9 and FIG. 10 illustrate bottom views of a portion of the multi-stage plant cultivation system shown in FIG. 2, FIG. 3, and FIG. 4;

FIG. 11 illustrates a perspective view of an example of the vegetation module of the multi-stage plant cultivation system shown in FIG. 2, FIG. 3, and FIG. 4;

FIG. 12 illustrates a front view of an example of a growing module of the multi-stage plant cultivation system shown in FIG. 2, FIG. 3, and FIG. 4;

FIG. 13 and FIG. 14 illustrate front views of the multi-stage plant cultivation system shown in FIG. 2, FIG. 3, and FIG. 4;

FIG. 15 and FIG. 16 illustrate front views of the multi-stage plant cultivation system shown in FIG. 2, FIG. 3, and FIG. 4 and wherein plants to be cultivated are present in the vegetation module and growing modules thereof;

FIG. 17 illustrates a perspective view of an example of a configuration of the multi-stage plant cultivation system shown in FIG. 2, FIG. 3, and FIG. 4 that further includes water storage tanks at each module;

FIG. 18 illustrates a perspective view of an example of a configuration of the multi-stage plant cultivation system shown in FIG. 2, FIG. 3, and FIG. 4 that further includes enclosed growing modules;

FIG. 19 illustrates a flow diagram of an example of a method of using the multi-stage plant cultivation system for enhancing plant production efficiency, in accordance with an embodiment of the invention;

FIG. 20A, FIG. 20B, FIG. 20C, FIG. 20D, and FIG. 20E illustrate pictorially certain steps of the method shown in FIG. 19;

FIG. 21 and FIG. 22 illustrate a front view and an end view, respectively, of an example of a stacked configuration of multiple multi-stage plant cultivation systems, in accordance with an embodiment of the invention; and

FIG. 23 illustrates a perspective view of an example of an arrangement of multiple stacked multi-stage plant cultivation systems, in accordance with an embodiment of the invention.

### DETAILED DESCRIPTION

The subject matter of the present invention now will be described more fully hereinafter with reference to the accompanying drawings, in which some, but not all embodiments of the subject matter of the present invention are shown. Like numbers refer to like elements throughout. The subject matter of the present invention may be embodied in many different forms and should not be construed as limited to the embodiments set forth herein; rather, these embodiments are provided so that this disclosure will satisfy applicable legal requirements. Indeed, many modifications and other embodiments of the subject matter of the present invention set forth herein will come to mind to one skilled in the art to which the subject matter of the present invention pertains having the benefit of the teachings presented in the foregoing descriptions and the associated drawings. Therefore, it is to be understood that the subject matter of the present invention is not to be limited to the specific embodiments disclosed and that modifications and other embodiments are intended to be included within the scope of the appended claims.

In some embodiments, the subject matter of the present invention provides a multi-stage plant cultivation system for and method of enhancing plant production efficiency through the full growing life cycle of a plant.

In some embodiments, the presently disclosed multi-stage plant cultivation system and method may provide an arrangement of growing modules that may be tailored with respect to known plant growing phases that may include, for example, in order, the germination growing phase, the seedling growing phase, the vegetative growing phase, the flowering growing phase, and then harvesting.

In some embodiments, the presently disclosed multi-stage plant cultivation system and method may provide a vegetation module and multiple growing modules arranged sequentially and wherein the full growing life cycle of a plant may be performed within the modules.

In some embodiments, the presently disclosed multi-stage plant cultivation system and method may provide in order a vegetation module, then a first growing module, then a second growing module, then a third growing module, and then a fourth growing module.

In some embodiments, the presently disclosed multi-stage plant cultivation system and method may provide a vegetation module in which the germination, seedling, and/or vegetative growing phases of plants may occur.

In some embodiments, the presently disclosed multi-stage plant cultivation system and method may provide a first growing module in which a first-stage flowering phase of plants may occur, a second growing module in which a second-stage flowering phase of plants may occur, a third growing module in which a third-stage flowering phase of plants may occur, and a fourth growing module in which a fourth-stage flowering phase of plants may occur.

In some embodiments, the presently disclosed multi-stage plant cultivation system and method may provide a vegetation module and multiple growing modules that may further include a plant transport system, one or more air handler systems, one or more lighting systems, one or more water delivery systems, one or more wastewater systems, and a controller.

In some embodiments, the presently disclosed multi-stage plant cultivation system and method may provide a process in which a batch of plants is processed at a vegetation module for a certain amount of time, then the same batch of plants is advanced to and processed at a first growing module for a certain amount of time, then the same batch of plants is advanced to and processed at a second growing module for a certain amount of time, then the same batch of plants is advanced to and processed at a third growing module for a certain amount of time, then the same batch of plants is advanced to and processed at a fourth growing module for a certain amount of time, then the same batch of plants is removed from the presently disclosed multi-stage plant cultivation system and advanced to downstream harvesting processes.

In some embodiments, the presently disclosed multi-stage plant cultivation system and method may provide a process in which a one batch of plants is being processed at a vegetation module, while at the same time another batch of plants is being processed at a first growing module, while at the same time yet another batch of plants is being processed at a second growing module, while at the same time yet another batch of plants is being processed at a third growing module, and while at the same time still another batch of plants is being processed at a fourth growing module.

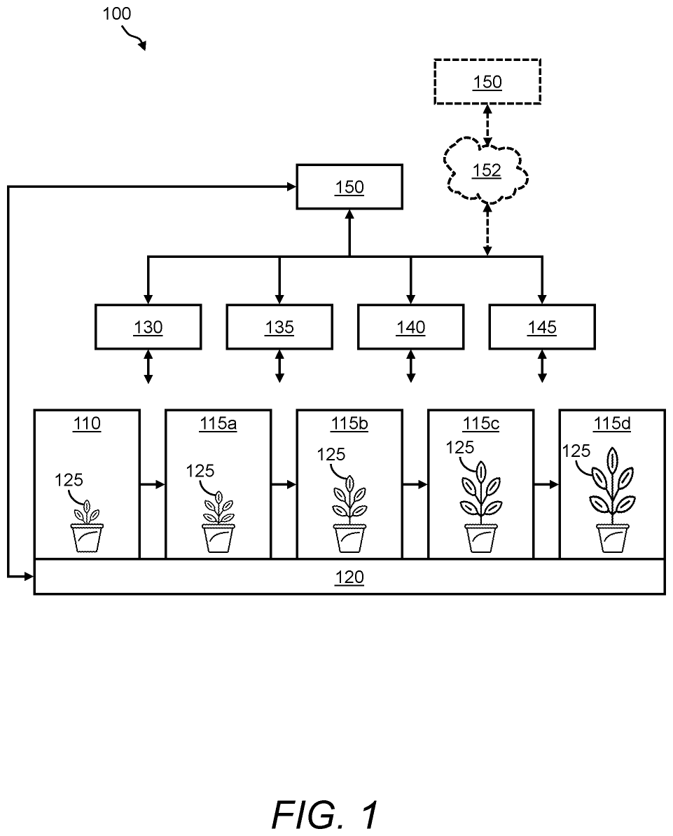

Referring now to FIG. 1 is a block diagram of an example of a plant cultivation system 100 for enhancing plant production efficiency, in accordance with an embodiment of the invention. Plant cultivation system 100 may be a multi-stage system that may include, for example, one vegetation module 110 and multiple growing modules 115 that are arranged in sequential order. In a plant cultivation process, plant cultivation system 100 may be designed to support in an automated and efficient manner some or all of the plant growing stages or phases. Namely, the full growing life cycle of a plant may be performed within vegetation module 110 and multiple growing modules 115 of plant cultivation system 100. The various plant growing phases may include, for example, germination, seedling, vegetative, flowering, and then harvesting.

In one example, FIG. 1 shows a configuration of plant cultivation system 100 that includes one vegetation module 110 and four growing modules 115 (e.g., 115a, 115b, 115c, 115d). In this example, plant cultivation system 100 may include in order vegetation module 110, then growing module 115a, then growing module 115b, then growing module 115c, and then growing module 115d. Further, in this example, the germination, seedling, and vegetative growing phases of plants may occur in vegetation module 110. Then, a first-stage flowering phase of plants may occur in growing module 115a. Then, a second-stage flowering phase of plants may occur in growing module 115b. Then, a third-stage flowering phase of plants may occur in growing module 115c. Then, a fourth-stage flowering phase of plants may occur in growing module 115d.

However, plant cultivation system 100 is not limited to one vegetation module 110 and four growing modules 115 (e.g., 115a, 115b, 115c, 115d). This is exemplary only. Plant cultivation system 100 may include any number of vegetation modules 110 and growing modules 115.

In one example, vegetation module 110 may be a self-contained module or space that may be highly environmentally controlled with respect to growing conditions therein. For example, vegetation module 110 may be highly controlled with respect to airflow, humidity, temperature, light, water delivery, wastewater removal, and plant residence time.

In one example, each of the growing modules 115 may be a module or space that may include certain environmental controls with respect to growing conditions therein, but less environmentally controlled than vegetation module 110. For example, growing modules 115 may be highly controlled with respect to light, water delivery, wastewater removal, and plant residence time, but less highly controlled compared with vegetation module 110 with respect to airflow, humidity, and temperature.

Accordingly, plant cultivation system 100 may include certain subsystems for supporting the plant cultivation processes of vegetation module 110 and growing modules 115. For example, plant cultivation system 100 may further include a transport system 120, one or more air handler systems 130, one or more lighting systems 135, one or more water delivery systems 140, and one or more wastewater removal systems 145. Additionally, plant cultivation system 100 may include a controller 150 for managing the overall operations of plant cultivation system 100.

Transport system 120 of plant cultivation system 100 may be any transport system capable of automatically translating or moving some number of plants 125 along plant cultivation system 100. For example, transport system 120 may be a common transport system for moving plants 125 from vegetation module 110 to growing module 115a, then to growing module 115b, then to growing module 115c, and then to growing module 115d. Transport system 120 may be, for example, a conveyor belt system, a gravity-based roller system, a motorized roller system, a gravity-based rail system, a motorized rail system, and the like.

The one or more air handler systems 130 of plant cultivation system 100 may include any air handler systems 130 for supporting the growing environments of vegetation module 110 and growing modules 115. For example, air handler systems 130 may include one air handler system that supports vegetation module 110 only. Further, air handler systems 130 may include other air handler systems that support any combinations of, for example, the multiple growing modules 115. For example, air handler systems 130 may include an air handler system that supports growing modules 115a, 115b and another air handler system that supports growing modules 115c, 115d.

The one or more lighting systems 135 of plant cultivation system 100 may include any lighting systems suitable for growing plants, sometimes called grow lights. Lighting systems 135 may include, for example, light-emitting diode (LED) white light sources, florescent white light sources, and the like. For example, lighting systems 135 may include one lighting system that supports vegetation module 110 only. Further, lighting systems 135 may include another lighting system that supports in common the multiple growing modules 115. Further, lighting systems 135 may be individually controlled in vegetation module 110 and any of the growing modules 115. Further, lighting systems 135 may have a suitably high water rating so that they may operate in a wet environment.

The one or more water delivery systems 140 of plant cultivation system 100 may include any water delivery systems suitable for growing plants. For example, water delivery systems 140 may include one water delivery system that supports vegetation module 110 only. Further, water delivery systems 140 may include another water delivery system that supports in common the multiple growing modules 115. Water delivery systems 140 may include, for example, a water supply line to each module and any arrangements and/or combinations of, for example, sprinkler heads, spray heads, water spikes, flood systems, and the like. Additionally, water delivery systems 140 may include individual water storage tanks above each module that can hold water that is tailored for each growth stage. For example, the individual tanks may hold different nutrient mixtures for the different growth stages, respectively.

The one or more wastewater removal systems 145 of plant cultivation system 100 may include any wastewater systems suitable for growing plants. For example, wastewater removal systems 145 may include one wastewater system that supports vegetation module 110 only. Further, wastewater removal systems 145 may include another wastewater system that supports in common the multiple growing modules 115. Further, wastewater removal systems 145 may include one wastewater system that supports in common all modules (i.e., both vegetation module 110 and all growing modules 115).

Controller 150 of plant cultivation system 100 may be a microcontroller device, a microprocessor device, or any computing device, such as, but not limited to, a centralized server, a cloud server, a desktop computer, a laptop computer, a handheld computing device, a mobile phone (or smart phone), a tablet device, a smartwatch, and the like. A certain amount of data storage (e.g., a memory device, not shown) may be associated with controller 150. Additionally, controller 150 may be a networked computing device that may be accessible via a network 152. Network 152 may be, for example, a local area network (LAN) and/or a wide area network (WAN) for connecting to the Internet or to an Intranet.

Additionally, other embodiments of multi-stage plant cultivation system 100 may include granular automation that tracks each stage via video and also tracks plant-specific data (e.g., temperature, humidity, soil moisture, plant height, CO₂ levels, etc.) in order to reduce the human interaction required at each stage.

Referring still to FIG. 1, the operation of plant cultivation system 100 may be summarized as follows. In one example, a “batch” of plants 125 may be placed into vegetation module 110. The germination, seedling, and vegetative growing phases of plants 125 may occur in vegetation module 110. Plants 125 may be, for example, cannabis plants. For example, vegetation module 110 may provide a highly controlled light-tight and airtight environment in which plants 125 (e.g., cannabis plants 125) may grow for some period of time, such as about two weeks. During this two-week period, lighting system 135 may be cycled on and off at predetermined times. Further, vegetation module 110 may be highly controlled for the type of plant 125 being grown with respect to airflow, humidity, temperature, water delivery, and wastewater removal. In this example, at the end of about two weeks the germination, seedling, and vegetative growing phases of this “batch” of plants 125 may be substantially complete. Therefore, using transport system 120, this “batch” of plants 125 may be automatically translated or moved out of vegetation module 110 and into growing module 115a.

Next, a first-stage flowering phase of plants 125 (e.g., cannabis plants 125) may occur in growing module 115a. For example, growing module 115a may provide a controlled environment in which the plants 125 may grow for some period of time, such as about two weeks. The environment of growing module 115a may be controlled for the type of plant 125 being grown with respect to airflow, humidity, temperature, light, water delivery, wastewater removal, and plant residence time. In this example, at the end of about two weeks the first-stage flowering phase of plants 125 may be substantially complete. Therefore, using transport system 120, this “batch” of plants 125 may be automatically translated or moved out of growing module 115a and into growing module 115b.

Next, a second-stage flowering phase of plants 125 (e.g., cannabis plants 125) may occur in growing module 115b. For example, growing module 115b may provide a controlled environment in which the plants 125 may grow for some period of time, such as about two weeks. The environment of growing module 115b may be controlled for the type of plant 125 being grown with respect to airflow, humidity, temperature, light, water delivery, wastewater removal, and plant residence time. In this example, at the end of about two weeks the second-stage flowering phase of plants 125 may be substantially complete. Therefore, using transport system 120, this “batch” of plants 125 may be automatically translated or moved out of growing module 115b and into growing module 115c.

Next, a third-stage flowering phase of plants 125 (e.g., cannabis plants 125) may occur in growing module 115c. For example, growing module 115c may provide a controlled environment in which the plants 125 may grow for some period of time, such as about two weeks. The environment of growing module 115c may be controlled for the type of plant 125 being grown with respect to airflow, humidity, temperature, light, water delivery, wastewater removal, and plant residence time. In this example, at the end of about two weeks the third-stage flowering phase of plants 125 may be substantially complete. Therefore, using transport system 120, this “batch” of plants 125 may be automatically translated or moved out of growing module 115c and into growing module 115d.

Next, a fourth-stage flowering phase of plants 125 (e.g., cannabis plants 125) may occur in growing module 115d. For example, growing module 115d may provide a controlled environment in which the plants 125 may grow for some period of time, such as about two weeks. The environment of growing module 115d may be controlled for the type of plant 125 being grown with respect to airflow, humidity, temperature, light, water delivery, wastewater removal, and plant residence time. In this example, at the end of about two weeks the fourth-stage flowering phase of plants 125 may be substantially complete. Now, this “batch” of plants 125 may be removed from growing module 115d and transported away from plant cultivation system 100 to downstream harvesting processes.

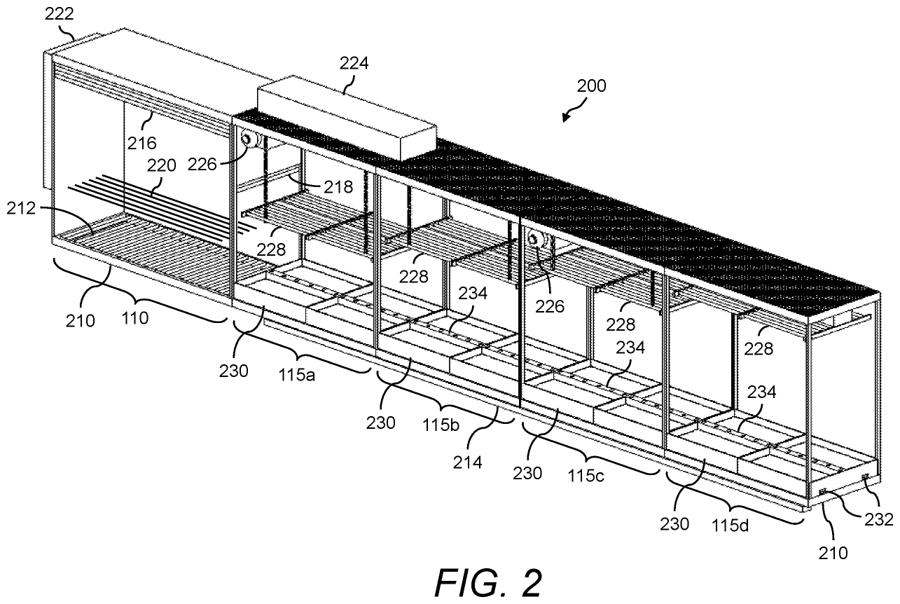

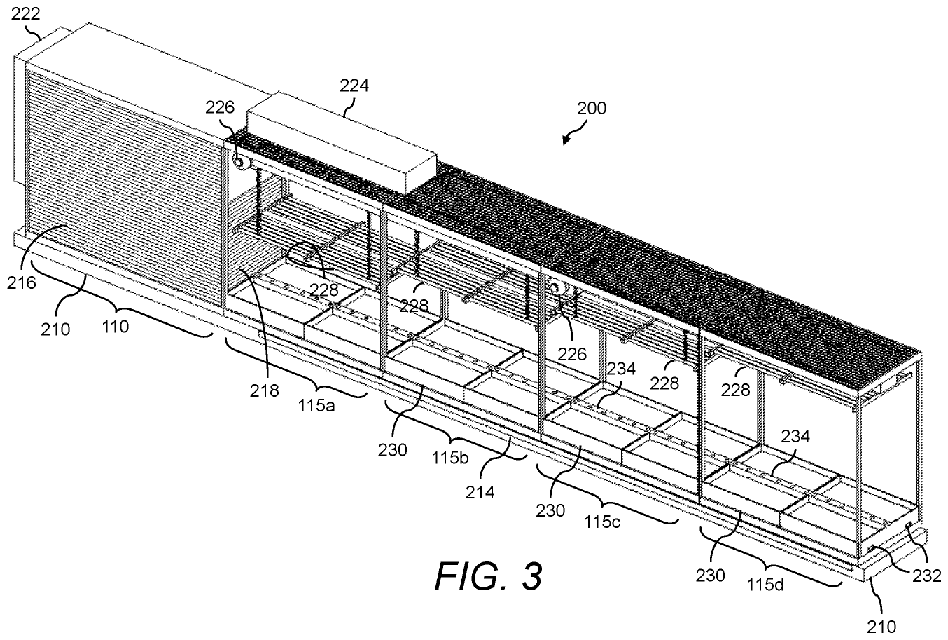

More details of examples of plant cultivation system 100 including vegetation module 110 and multiple growing modules 115 are shown and described hereinbelow with reference to FIG. 2 through FIG. 18. Likewise, more details of examples of transport system 120, air handler systems 130, lighting systems 135, water delivery systems 140, and wastewater removal systems 145 are shown and described hereinbelow with reference to FIG. 2 through FIG. 18.

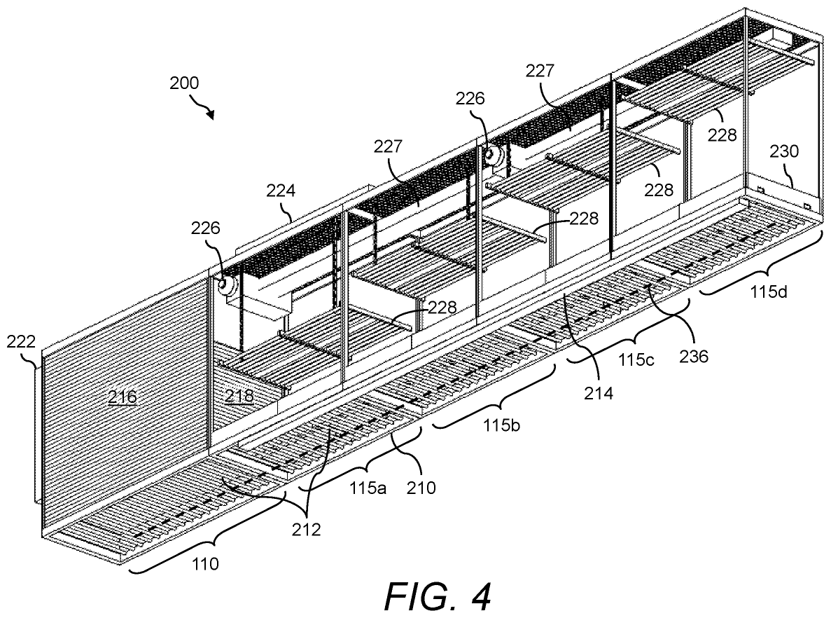

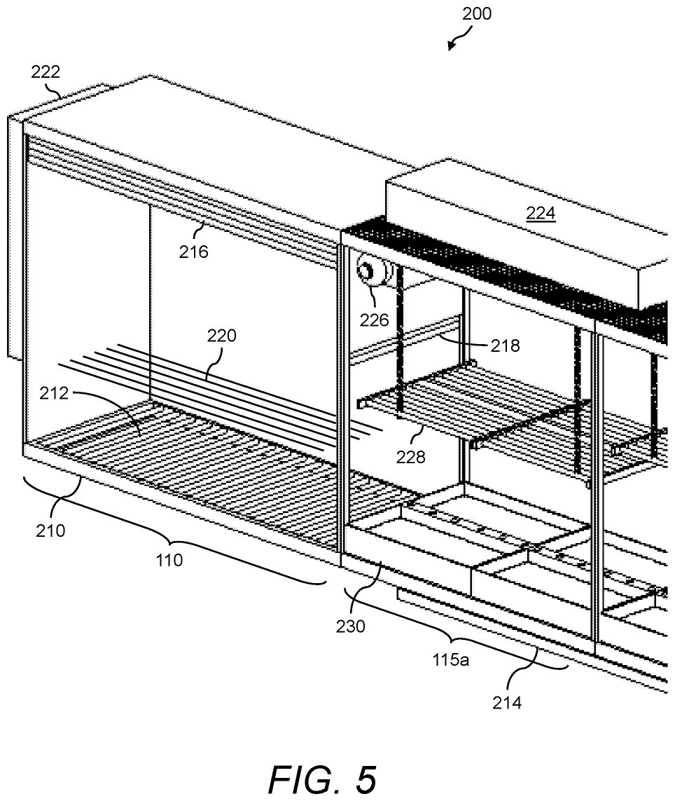

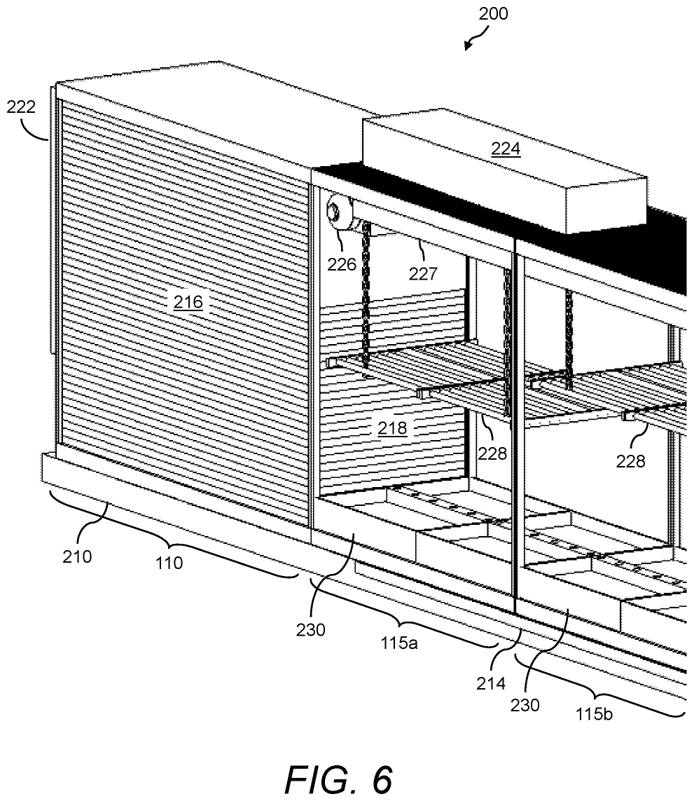

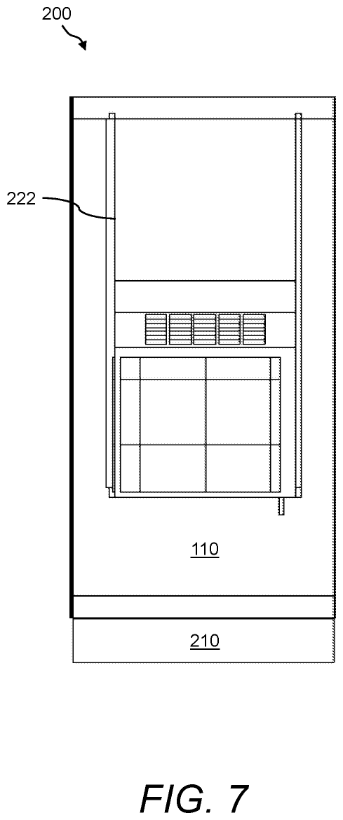

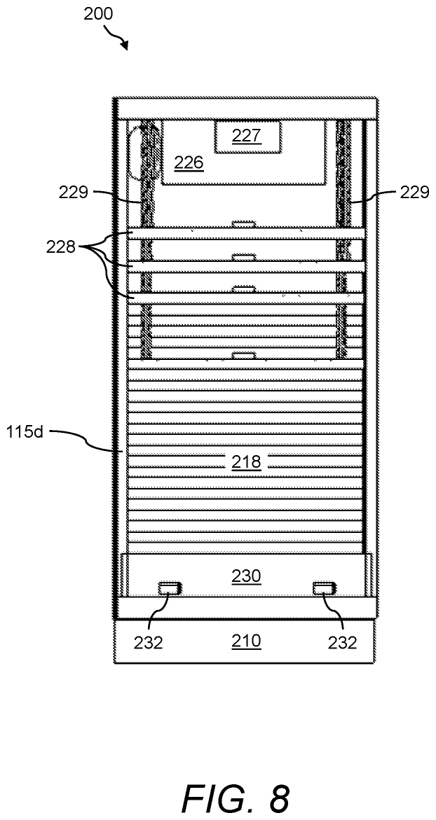

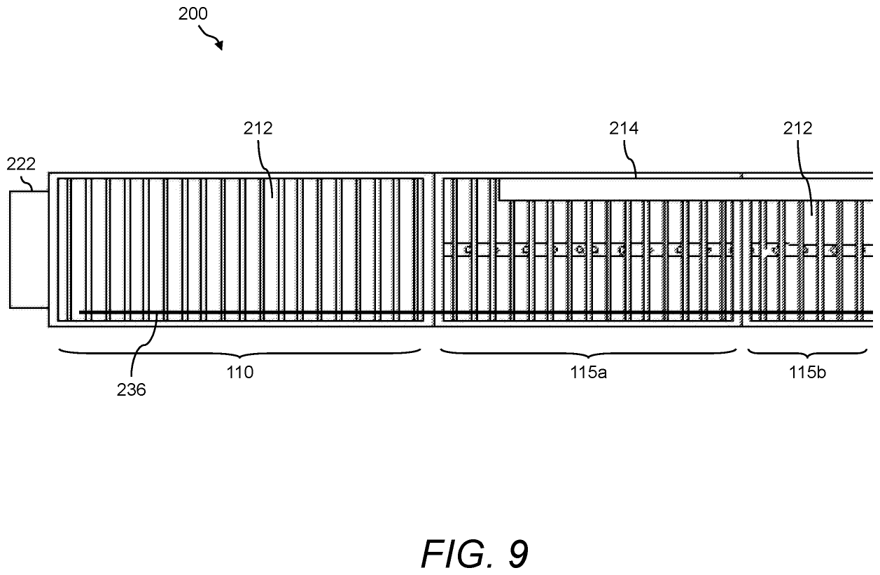

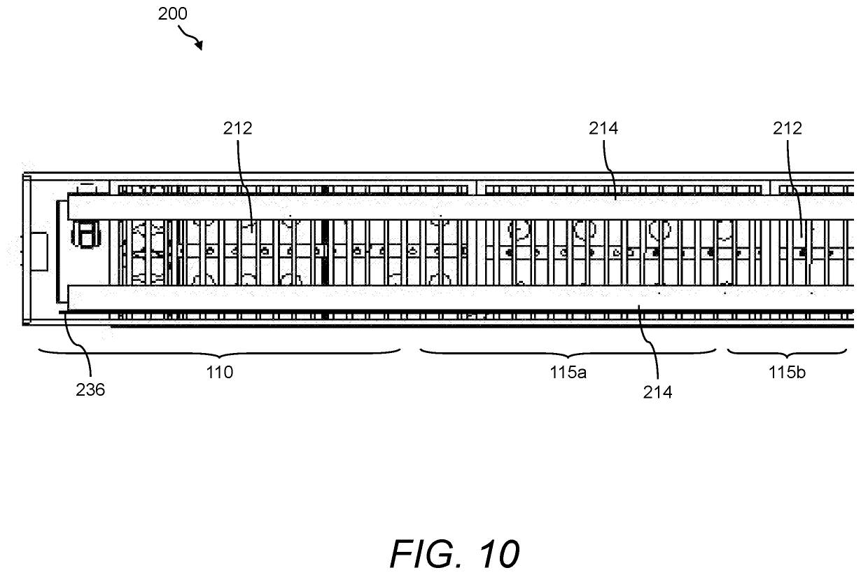

Referring now to FIG. 2, FIG. 3, and FIG. 4 is perspective views of a multi-stage plant cultivation system 200, which may be an example of one instance of the multi-stage plant cultivation system 100 shown in FIG. 1, in accordance with an embodiment of the invention. Referring now to FIG. 5 and FIG. 6 illustrate perspective views of a vegetation module portion of the multi-stage plant cultivation system 200 shown in FIG. 2, FIG. 3, and FIG. 4 and wherein the door of the vegetation module is open and closed, respectively. Further, FIG. 7 and FIG. 8 show end views of the multi-stage plant cultivation system 200 shown in FIG. 2, FIG. 3, and FIG. 4. Further, FIG. 9 and FIG. 10 show bottom views of a portion of the multi-stage plant cultivation system 200 shown in FIG. 2, FIG. 3, and FIG. 4.

Referring now to FIG. 2 through FIG. 10, plant cultivation system 200 may include one vegetation module 110 and four growing modules 115 (e.g., 115a, 115b, 115c, 115d). In this example, plant cultivation system 200 may include in order vegetation module 110, then growing module 115a, then growing module 115b, then growing module 115c, and then growing module 115d. Further, in plant cultivation system 200, the germination, seedling, and vegetative growing phases of plants may occur in vegetation module 110. Then, a first-stage flowering phase of plants may occur in growing module 115a. Then, a second-stage flowering phase of plants may occur in growing module 115b. Then, a third-stage flowering phase of plants may occur in growing module 115c. Then, a fourth-stage flowering phase of plants may occur in growing module 115d.

In plant cultivation system 200, vegetation module 110 and the four growing modules 115a, 115b, 115c, 115d may be arranged in a line atop an undercarriage 210. Undercarriage 210 may also house a roller transport system 212 that may span the full distance of all five modules. In one example, undercarriage 210 may be a fixed undercarriage. In another example, undercarriage 210 may be a mobile undercarriage that allows plant cultivation system 200 to be easily moved. Further, at least one wastewater drain gutter 214 may be provided along undercarriage 210. Wastewater drain gutter 214 may be used to drain wastewater away from plant cultivation system 200. For example, wastewater drain gutter 214 may be used to channel waste-water to be recycled or disposed of according to municipality grey water codes.

For example, FIG. 9 is a bottom view showing plant cultivation system 200 with one wastewater drain gutter 214, while FIG. 10 is a bottom view showing plant cultivation system 200 with two wastewater drain gutters 214. Further, at least one water supply line 236 may be provided along undercarriage 210. Water supply line 236 may be provided to supply water to vegetation module 110 and the four growing modules 115a, 115b, 115c, 115d.

Vegetation module 110 of plant cultivation system 200 may be, for example, a metal frame structure that is designed to be airtight, light-tight, and to maintain certain environmental controls. Vegetation module 110 may be sized to any scale. For example, vegetation module 110 may be from about 54 inches to about 120 inches wide (or long), from about 48 inches to about 54 inches deep, and from about 72 inches to about 96 inches high. In one example, vegetation module 110 may be about 120 inches wide (or long), about 48 inches deep, and about 78 inches high.

Vegetation module 110 may include a front access door 216 and a side exit door 218. Front access door 216 may span substantially the full width and height of vegetation module 110. Side exit door 218 may span substantially the full depth and partial height of vegetation module 110. Both front access door 216 and side exit door 218 may be, for example, rollup type doors that are suitable to maintain airtight and light-tight conditions within vegetation module 110. For example, front access door 216 and side exit door 218 may be rollup type aluminum slat doors that may seal against air and light. In this example, the aluminum slats slide together to provide a light-tight and airtight seal. In another example, front access door 216 and side exit door 218 may include plastic slats.

Further, the seals of front access door 216 and side exit door 218 may be formed of a thermoplastic elastomer, such as Santoprene™ thermoplastic vulanizate (TPV), which has a high resistance to ultraviolet (UV) light and adjusts very well to both extreme cold and hot temperatures. A “G-Rib” design also has a polyurethane seal that rests up against the following rib creating a weather-tight seal when the door is closed, offering superior protection against leaking.

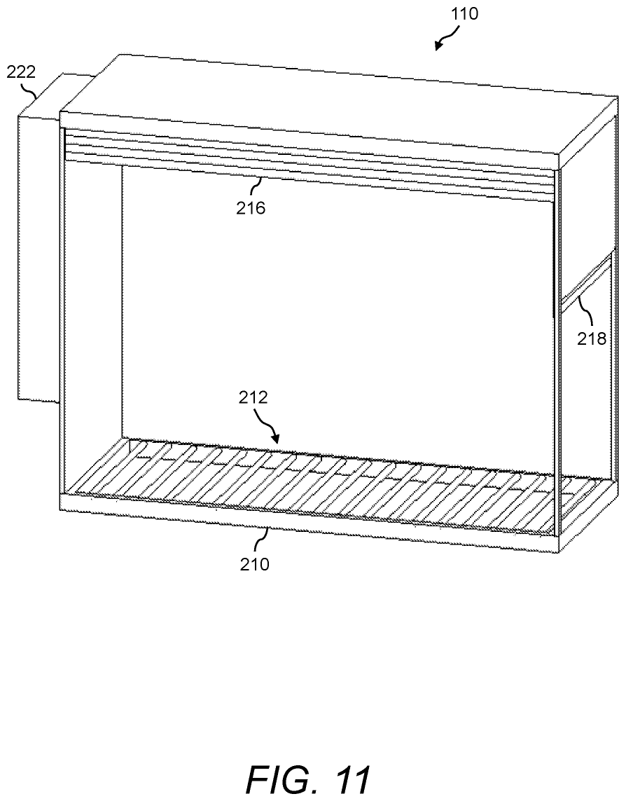

Further to the example, FIG. 11 shows a perspective view of an example of vegetation module 110 with front access door 216 and side exit door 218 open. Further, FIG. 2 and FIG. 5 show vegetation module 110 with front access door 216 and side exit door 218 open. Further, FIG. 3, FIG. 4, FIG. 6, and FIG. 8 show vegetation module 110 with front access door 216 and side exit door 218 closed.

Additionally, an arrangement of grow lights 220 may be provided inside vegetation module 110. Grow lights 220 may be, for example, LED lights and/or florescent lights. Further, grow lights 220 may have a suitably high water rating so that they may operate in a wet environment. Further, an air handler unit 222 may be provided at vegetation module 110. Air handler unit 222 may be, for example, a quarter-ton to half-ton heating, ventilation, and air conditioning (HVAC) unit. Further, air handler unit 222 may include certain quality air filters (not shown). In one example, air handler unit 222 provides the environment control mechanism of vegetation module 110 only. For processing cannabis plants 125, for example, air handler unit 222 may be used to hold vegetation module 110 at, for example, from about 72 degrees F. to about 84 degrees F. Additionally, air handler unit 222 may be used to pull in fresh air from the surrounding environment. Adding fresh air accomplishes two primary Indoor Air Quality (IAQ) goals: (1) it controls air pressures of vegetation module 110 and (2) it increases IAQ by diluting stale air. Further, in one example, controller 150 shown in FIG. 1 may be housed in air handler unit 222 at vegetation module 110.

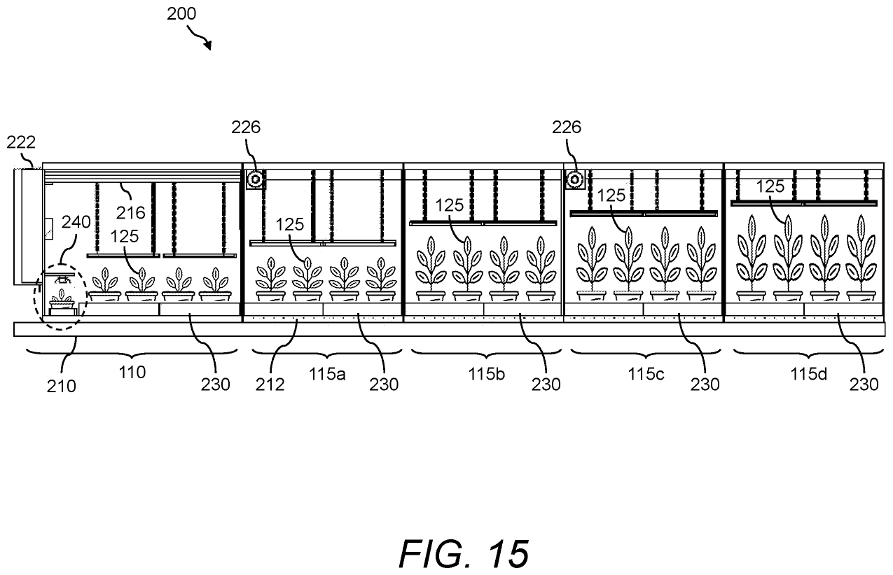

A portion of roller transport system 212 may span the width of vegetation module 110. When in use, one or more grow trays 230 holding plants 125 may be placed inside vegetation module 110 and sit atop roller transport system 212, as shown, for example, in FIG. 15. When a certain “batch” of plants 125 have finished processing within vegetation module 110, then roller transport system 212 may be used to easily move the grow trays 230 holding plants 125 out of vegetation module 110 and into growing module 115a. That is, by pushing on grow trays 230, grow trays 230 may easily roll atop roller transport system 212 from vegetation module 110 into growing module 115a. Additionally, roller transport system 212 may include a roller system brake (not shown). Additionally, roller transport system 212 may include a mobile carriage that allows grow trays 230 to move forward, as a stage, along a rail flow and roller system, like train tracks.

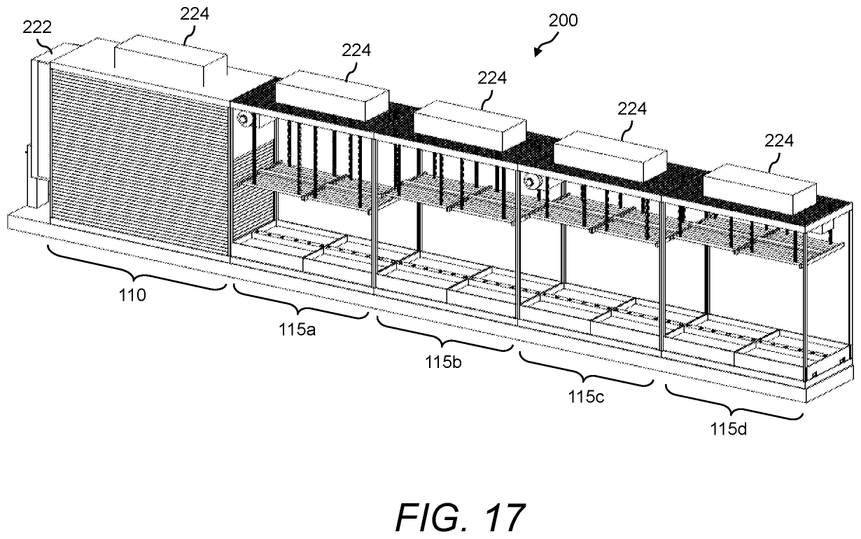

Further, at least a portion of wastewater drain gutter 214 and water supply line 236 extend to vegetation module 110 via undercarriage 210. Water supply line 236 may be used to supply any plant watering mechanisms (not shown) of vegetation module 110, while wastewater drain gutter 214 may be used to catch and carry away any wastewater. The plant watering mechanisms (not shown) of vegetation module 110 may be, for example, any arrangements and/or combinations of sprinkler heads, spray heads, water spikes, flood systems, and the like. An arrangement of quick-connects/disconnects may be provided along the length of water supply line 236. Additionally, the plant watering mechanisms (not shown) of vegetation module 110 may include a water storage tank 224 mounted atop vegetation module 110, as shown, for example, in FIG. 17.

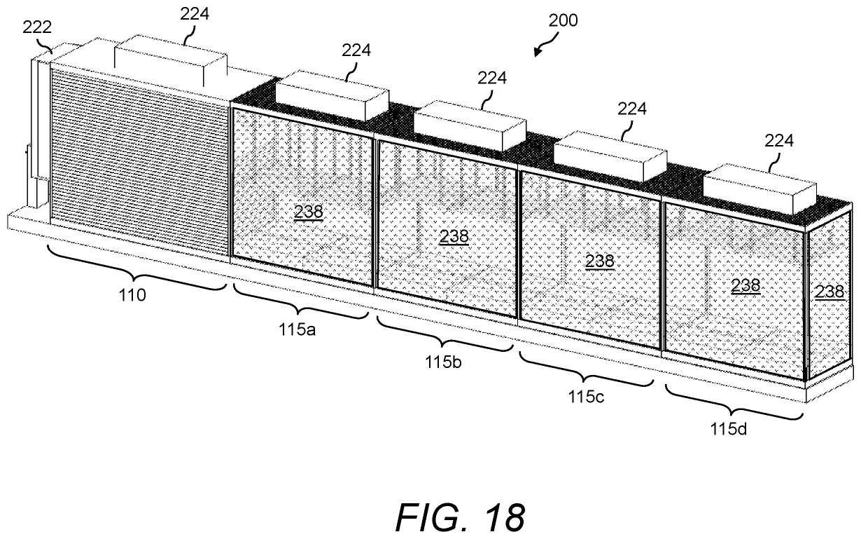

Each of the growing modules 115 of plant cultivation system 200 may be, for example, a substantially open metal frame structure. However, in some embodiments, the structure of growing modules 115 may be enclosed to some degree, as shown, for example, in FIG. 18. Each of the growing modules 115 may be sized to any scale. For example, each of the growing modules 115 may be from about 96 inches to about 120 inches wide (or long), from about 48 inches to about 54 inches deep, and from about 72 inches to about 96 inches high. In one example, each of the growing modules 115 may be about 96 inches wide (or long), about 54 inches deep, and about 78 inches high.

In the case wherein vegetation module 110 may be about 120 inches (about 10 feet) wide (or long) and about 48 inches (about 4 feet) deep and wherein each of the growing modules 115 may be about 96 inches (about 8 feet) wide (or long) and about 48 inches (about 4 feet) deep, then undercarriage 210 may be about 504 inches (about 42 feet) long and about 48 inches (about 4 feet) wide.

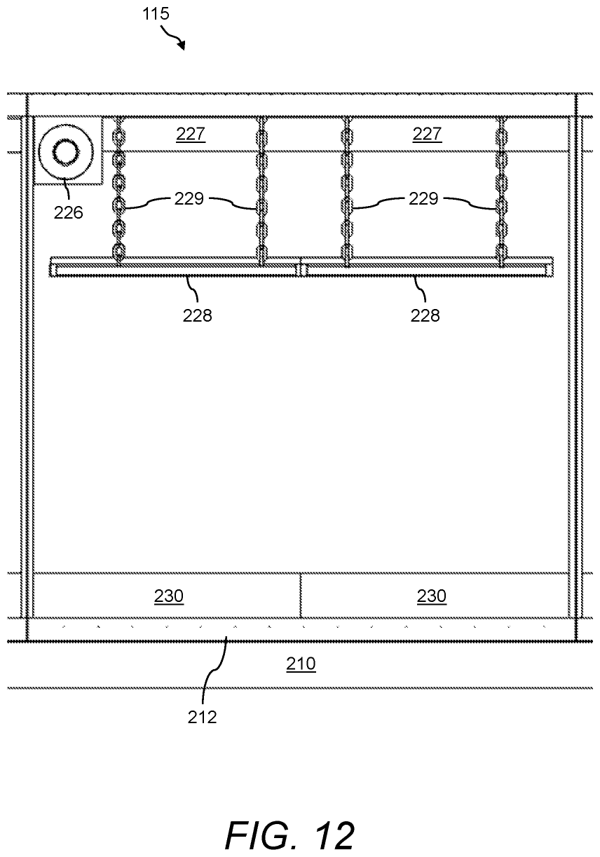

Additionally, an arrangement of grow lights 228 may be provided inside each of the growing modules 115. Grow lights 228 may be, for example, LED lights and/or florescent lights. Further, grow lights 228 may have a suitably high water rating so that they may operate in a wet environment. A portion of roller transport system 212 may span the width of each of the growing modules 115. Accordingly, roller transport system 212 may span the entire length of vegetation module 110 and the four growing modules 115 (e.g., 115a, 115b, 115c, 115d). Further to the example, FIG. 12 shows a front view of one growing module 115 and further showing grow lights 228 hung, for example, via adjustable light hangers 229.

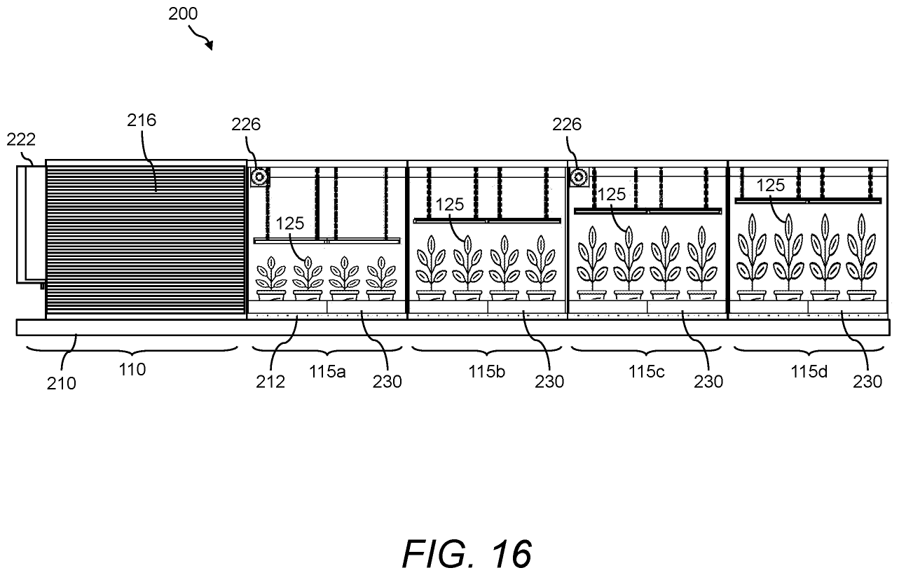

When in use, one or more grow trays 230 holding plants 125 may be placed inside each of the growing modules 115 and sit atop roller transport system 212, as shown, for example, in FIG. 15 and FIG. 16. When a certain “batch” of plants 125 have finished processing within each of the growing modules 115, then roller transport system 212 may be used to easily move the grow trays 230 holding plants 125 out of a certain growing module 115 and into the next growing module 115. That is, by pushing on grow trays 230, grow trays 230 may easily roll atop roller transport system 212 from one growing module 115 to the next growing module 115.

Further, both wastewater drain gutter 214 and water supply line 236 span the entire length of vegetation module 110 and the four growing modules 115 (e.g., 115a, 115b, 115c, 115d) via undercarriage 210. Water supply line 236 may be used to supply any plant watering mechanisms (not shown) of each of the growing modules 115, while wastewater drain gutter 214 may be used to catch and carry away any wastewater. The plant watering mechanisms (not shown) of each of the growing modules 115 may be, for example, any arrangements and/or combinations of sprinkler heads, spray heads, water spikes, flood systems, and the like. Additionally, the plant watering mechanisms (not shown) may include a water storage tank 224 mounted atop each of the growing modules 115, as shown, for example, in FIG. 17. Further to the example, FIG. 2 through FIG. 6 show a water storage tank 224 at growing module 115a only.

In plant cultivation system 200, the height of grow lights 220 of vegetation module 110 and the height of grow lights 228 of each of the growing modules 115, respectively, may be adjusted according to the expected height of the plants 125 (see FIG. 15). That is, grow lights 220 in vegetation module 110 and grow lights 228 in each of the growing modules 115 may be hung, for example, via adjustable light hangers 229 (see FIG. 12).

Referring still to FIG. 2 through FIG. 10, one air blower 226 (e.g., inline circulation fan) may be provided at growing module 115a. This air blower 226 may be used to provide outside air to both growing modules 115a and 115b via a length of air duct 227 (e.g., fresh air circulation duct). Another air blower 226 (e.g., inline circulation fan) may be provided at growing module 115c. This air blower 226 may be used to provide outside air to both growing modules 115c and 115d via another length of air duct 227 (e.g., fresh air circulation duct). The air blowers 226 may be used to evenly distribute air flow through the plant canopy to regulate even temperatures and to cause subtle plant movement, in order to help strengthen the plants stems and to help prevent pathogens. Further, air blowers 226 and air ducts 227 may be used to pull in fresh air from the surrounding environment. Adding fresh air accomplishes two primary Indoor Air Quality (IAQ) goals: (1) it controls air pressures of growing modules 115 and (2) it increases IAQ by diluting stale air.

Additionally, in one example, grow trays 230 that may be used to hold plants 125 may be suited for loading and unloading using a forklift. For example, each grow tray 230 may be a 4 ft×4 ft tray with fork pockets 232 (see FIG. 2, FIG. 3, FIG. 8). Additionally, an air channel 234 may be provided along the center portion of each grow tray 230, as shown, for example, in FIG. 2 and FIG. 3. Air channels 234 in grow trays 230 allow for the possibility of air blowing up from the bottom of vegetation module 110 and growing modules 115 and circulating through the foliage of plants 125.

Referring now to FIG. 2 through FIG. 12, roller transport system 212 of plant cultivation system 200 may be one example of transport system 120 of plant cultivation system 100 shown in FIG. 1. In one example, roller transport system 212 may be provided with a slight incline such that gravity may be used to assist the movement of grow trays 230 holding plants 125 from vegetation module 110 to, for example, growing module 115d. For example, if the span of transport system 120 along the entire length of plant cultivation system 200 is, for example, about 42 feet, then the end of roller transport system 212 at vegetation module 110 may be set at from about 1.5 inches to about 8 inches higher than the end of roller transport system 212 at growing module 115d.

In another example of roller transport system 212, instead of each roller spanning about the full width of undercarriage 210, a roller/rail system may be provided. In this example, two rails may be provided with a space in between (e.g., like railroad track) and wherein each rail may be an arrangement of small rollers (i.e., rail-width rollers).

Further, in plant cultivation system 200, air handler unit 222 at vegetation module 110 and air blowers 226 (e.g., inline circulation fans) of growing modules 115 may be examples of air handler systems 130 of plant cultivation system 100 shown in FIG. 1. Additionally, using controller 150 (see FIG. 1), air handler unit 222 at vegetation module 110 may be controlled independently. Likewise, air blowers 226 of growing modules 115 may be controlled independently.

Further, in plant cultivation system 200, grow lights 220 of vegetation module 110 and grow lights 228 of growing modules 115 may be examples of lighting systems 135 of plant cultivation system 100 shown in FIG. 1. Additionally, using controller 150 (see FIG. 1), grow lights 220 at vegetation module 110 may be controlled independently. Likewise, grow lights 228 at each of the growing modules 115 may be controlled independently.

Further, in plant cultivation system 200, water supply line 236 and any plant watering mechanisms (not shown) of vegetation module 110 and growing modules 115 may be an example of water delivery systems 140 of plant cultivation system 100 shown in FIG. 1. Additionally, using controller 150 (see FIG. 1), any plant watering mechanisms (not shown) at vegetation module 110 may be controlled independently. Likewise, any plant watering mechanisms (not shown) at each of the growing modules 115 may be controlled independently.

Further, in plant cultivation system 200, wastewater drain gutter 214 may be an example of wastewater removal systems 145 of plant cultivation system 100 shown in FIG. 1.

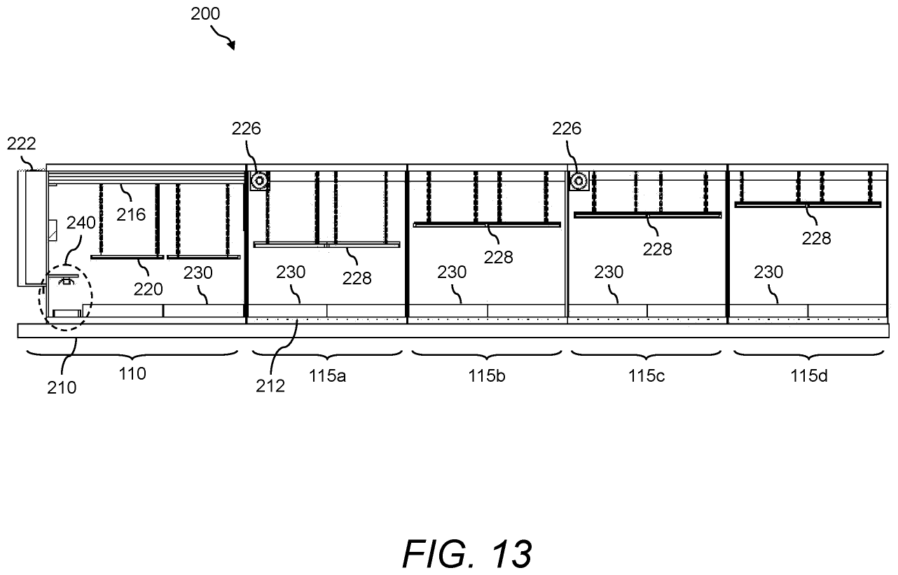

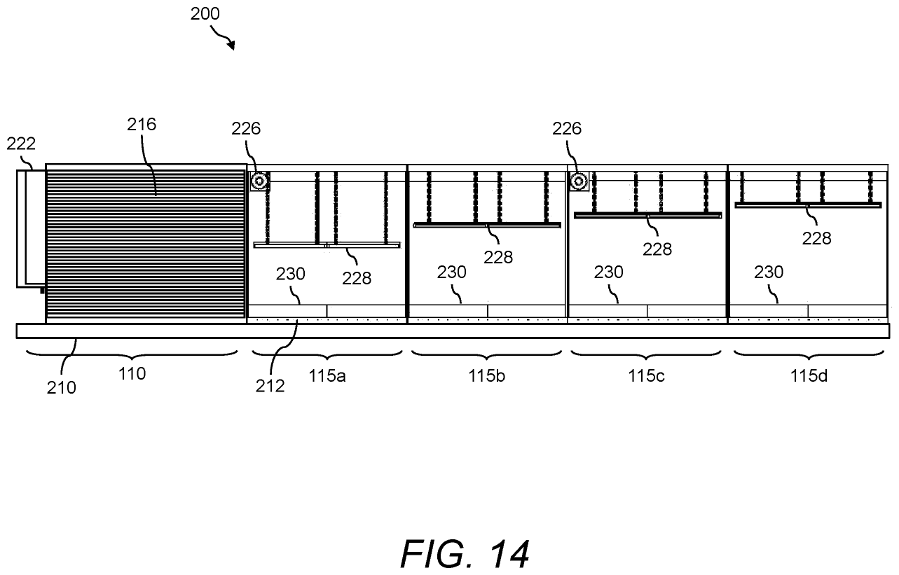

Referring now to FIG. 13 and FIG. 14 is front views of the multi-stage plant cultivation system 200 shown in FIG. 2, FIG. 3, and FIG. 4. Namely, FIG. 13 shows front access door 216 of vegetation module 110 open and no plants 125 present in any modules of plant cultivation system 200. FIG. 14 shows front access door 216 of vegetation module 110 closed and no plants 125 present in any modules of plant cultivation system 200.

Referring now to FIG. 15 and FIG. 16 is front views of the multi-stage plant cultivation system 200 shown in FIG. 2, FIG. 3, and FIG. 4 and wherein plants to be cultivated are present in vegetation module 110 and growing modules 115. Namely, FIG. 15 shows front access door 216 of vegetation module 110 open and with plants 125 present in all modules of plant cultivation system 200. FIG. 16 shows front access door 216 of vegetation module 110 closed and with plants 125 present in all modules of plant cultivation system 200.

In particular, FIG. 15 shows grow lights 220 of vegetation module 110 and grow lights 228 of each of the growing modules 115 set at different heights corresponding to the expected size of plants 125. For processing cannabis plants 125, for example, grow lights 220 of vegetation module 110 may be set at about 36 inches above grow trays 230, grow lights 228 of growing module 115a may be set at about 42 inches above grow trays 230, grow lights 228 of growing module 115b may be set at about 48 inches above grow trays 230, grow lights 228 of growing module 115c may be set at about 54 inches above grow trays 230, and grow lights 228 of growing module 115d may be set at about 60 inches above grow trays 230.

Additionally, FIG. 13 and FIG. 15 show that vegetation module 110 may further include a propagation region 240 where plant propagation may occur. After propagation, the propagated plants 125 may move to the main area of vegetation module 110.

Referring now to FIG. 17 is a perspective view of an example of a configuration of the multi-stage plant cultivation system 200 shown in FIG. 2, FIG. 3, and FIG. 4 that further includes water storage tanks 224 at each of the modules. In this example, vegetation module 110 has its own water storage tank 224. Growing module 115a has its own water storage tank 224. Growing module 115b has its own water storage tank 224. Growing module 115c has its own water storage tank 224. Growing module 115d has its own water storage tank 224. Using the multiple water storage tanks 224, the nutrients contents at each water storage tank 224 may be tailored for each growth stage. Further, each of the water storage tanks 224 mounted atop its respective module may support a gravity fed water supply.

Further, water storage tanks 224 may be provide reserve water supplies to plant cultivation system 200. For example, each gravity fed water storage tank 224 may hold a full day of water, if the facility water source were to fail. Each gravity fed water storage tank 224 may be connected to the facility water source, with a float, to ensure it is always full.

Further, additional environmental controls may be provided at the four growing modules 115 (e.g., 115a, 115b, 115c, 115d). For example, FIG. 18 shows an example of the multi-stage plant cultivation system 200 that further includes growing modules 115 that may be enclosed. For example, growing modules 115 may be enclosed to some degree using, for example, fixed or hanging enclosures 238, such as plastic or vinyl sheets or curtains. Fixed or hanging enclosures 238 may provide some isolation of growing modules 115 from the outside ambient air. Fixed or hanging enclosures 238 may also have certain characteristics with respect to allowing and/or blocking light. As a result, fixed or hanging enclosures 238 may provide a means of maintaining certain air, temperature, and/or light conditions within growing modules 115.

Namely, a main benefit of the presently disclosed multi-stage plant cultivation system 100, 200 may be the ability to isolate any plants 125 being processed therein from a certain amount of outside environmental conditions and/or contaminants that may put the health of plants 125 at risk. In other words, a main benefit of the presently disclosed multi-stage plant cultivation system 100, 200 may be the ability to maintain a healthy growing environment for any plants 125 being processed therein.

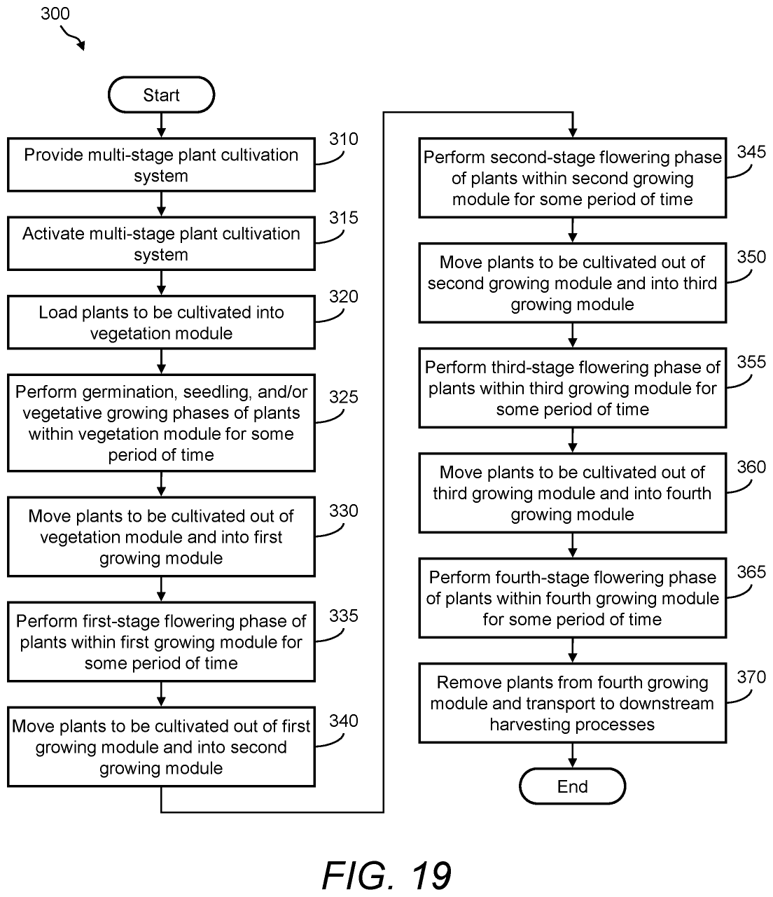

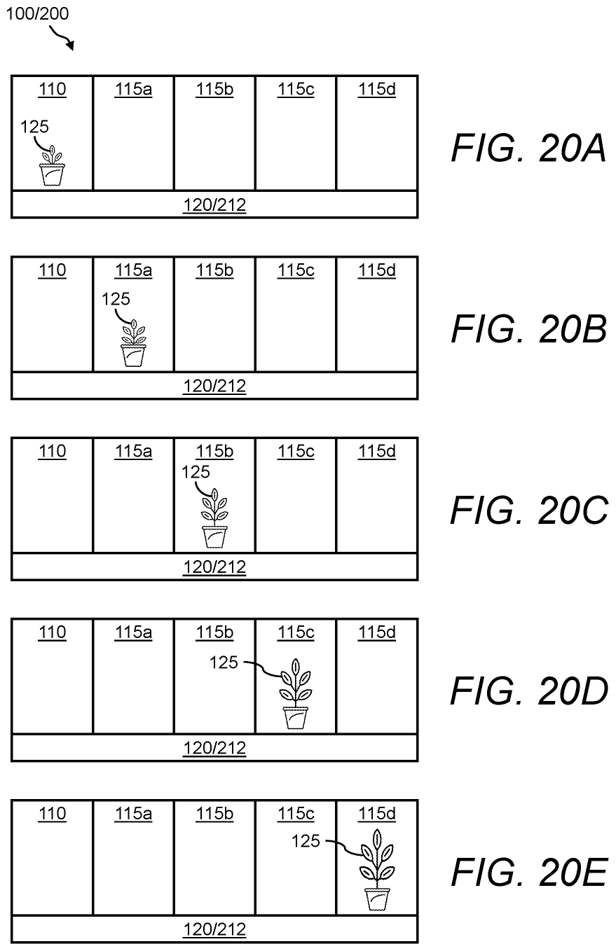

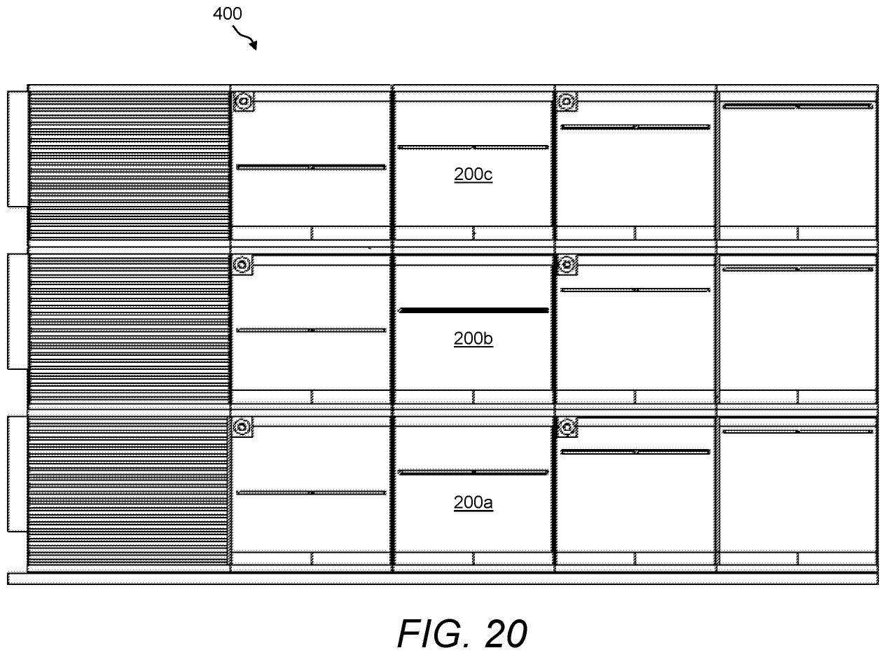

Referring now to FIG. 19 is a flow diagram of an example of a method 300 of using multi-stage plant cultivation system 100, 200 for enhancing plant production efficiency, in accordance with an embodiment of the invention. Additionally, FIG. 20A, FIG. 20B, FIG. 20C, FIG. 20D, and FIG. 20E show pictorially certain steps of method 300 shown in FIG. 19. Namely, method 300 may be used to perform the full growing life cycle of a plant within vegetation module 110 and the multiple growing modules 115 of plant cultivation system 100, 200. Method 300 may include, but is not limited to, the following steps.

At a step 310, the multi-stage plant cultivation system is provided. For example, the presently disclosed multi-stage plant cultivation system 100, 200 may be provided as described hereinabove with reference to FIG. 1 through FIG. 18. In one example, multi-stage plant cultivation system 100, 200 may include one vegetation module 110 and the four growing modules 115 (e.g., 115a, 115b, 115c, 115d).

At a step 315, the multi-stage plant cultivation system is activated. For example, using controller 150 (see FIG. 1), some or all subsystems of multi-stage plant cultivation system 100, 200 may be activated. For example and referring now to FIG. 1, transport system 120, the one or more air handler systems 130, the one or more lighting systems 135, the one or more water delivery systems 140, and the one or more wastewater removal systems 145 may be activated. In particular, parameters of multi-stage plant cultivation system 100, 200 may set for a certain type of plants 125, such as cannabis plants 125.

At a step 320, the plants to be cultivated are loaded into the vegetation module. For example and referring now to FIG. 20A, front access door 216 and side exit door 218 may be opened. Then, plants 125 (e.g., cannabis plants 125) on grow trays 230, which are the plants to be cultivated, may be loaded atop roller transport system 212 within vegetation module 110.

At a step 325, the germination, seedling, and/or vegetative growing phases of plants are performed within the vegetation module for some period of time. For example, front access door 216 and side exit door 218 of vegetation module 110 may be closed to provide an airtight and light-tight environment. Then, the germination, seedling, and/or vegetative growing phases of plants 125 (e.g., cannabis plants 125) may be performed within vegetation module 110 for about two weeks. During this two-week period, controller 150 may be used to manage the proper growing environment within vegetation module 110. For example, controller 150 may be used to control the light cycles of grow lights 220, the temperature via air handler unit 222, and watering via any plant watering mechanisms (not shown) of vegetation module 110.

At a step 330, the plants to be cultivated are moved out of the vegetation module and into the first growing module. For example and referring now to FIG. 20B, front access door 216 and side exit door 218 may be opened. Then, using roller transport system 212, plants 125 (e.g., cannabis plants 125) on grow trays 230, which are the plants to be cultivated, may be moved or pushed through side exit door 218 of vegetation module 110 and into growing module 115a (i.e., the first growing module).

At a step 335, the first-stage flowering phase of plants is performed within the first growing module for some period of time. For example and referring still to FIG. 20B, side exit door 218 of vegetation module 110 may be closed. Then, the first-stage flowering phase of plants 125 (e.g., cannabis plants 125) may be performed within growing module 115a for about two weeks. During this two-week period, controller 150 may be used to manage the proper growing environment within growing module 115a. For example, controller 150 may be used to control the light cycles of grow lights 228 of growing module 115a, the airflow via air blower 226, and watering via any plant watering mechanisms (not shown) of growing module 115a.

At a step 340, the plants to be cultivated are moved out of the first growing module and into the second growing module. For example and referring now to FIG. 20C, using roller transport system 212, plants 125 (e.g., cannabis plants 125) on grow trays 230, which are the plants to be cultivated, may be moved or pushed out of growing module 115a (i.e., the first growing module) and into growing module 115b (i.e., the second growing module).

At a step 345, the second-stage flowering phase of plants is performed within the second growing module for some period of time. For example and referring still to FIG. 20C, the second-stage flowering phase of plants 125 (e.g., cannabis plants 125) may be performed within growing module 115b for about two weeks. During this two-week period, controller 150 may be used to manage the proper growing environment within growing module 115b. For example, controller 150 may be used to control the light cycles of grow lights 228 of growing module 115b, the airflow via air blower 226, and watering via any plant watering mechanisms (not shown) of growing module 115b.

At a step 350, the plants to be cultivated are moved out of the second growing module and into the third growing module. For example and referring now to FIG. 20D, using roller transport system 212, plants 125 (e.g., cannabis plants 125) on grow trays 230, which are the plants to be cultivated, may be moved or pushed out of growing module 115b (i.e., the second growing module) and into growing module 115c (i.e., the third growing module).

At a step 355, the third-stage flowering phase of plants is performed within the third growing module for some period of time. For example and referring still to FIG. 20D, the third-stage flowering phase of plants 125 (e.g., cannabis plants 125) may be performed within growing module 115c for about two weeks. During this two-week period, controller 150 may be used to manage the proper growing environment within growing module 115c. For example, controller 150 may be used to control the light cycles of grow lights 228 of growing module 115c, the airflow via air blower 226, and watering via any plant watering mechanisms (not shown) of growing module 115c.

At a step 360, the plants to be cultivated are moved out of the third growing module and into the fourth growing module. For example and referring now to FIG. 20E, using roller transport system 212, plants 125 (e.g., cannabis plants 125) on grow trays 230, which are the plants to be cultivated, may be moved or pushed out of growing module 115c (i.e., the third growing module) and into growing module 115d (i.e., the fourth growing module).

At a step 365, the fourth-stage flowering phase of plants is performed within the fourth growing module for some period of time. For example and referring still to FIG. 20E, the fourth-stage flowering phase of plants 125 (e.g., cannabis plants 125) may be performed within growing module 115d for about two weeks. During this two-week period, controller 150 may be used to manage the proper growing environment within growing module 115d. For example, controller 150 may be used to control the light cycles of grow lights 228 of growing module 115d, the airflow via air blower 226, and watering via any plant watering mechanisms (not shown) of growing module 115d.

At a step 370, the plants are removed from the fourth growing module and transported to any downstream harvesting processes. For example, having completed substantially the full growing life cycle of plants 125 (e.g., cannabis plants 125) using vegetation module 110 and the multiple growing modules 115 of plant cultivation system 100, 200, a forklift may be used to remove plants 125 from into growing module 115d (i.e., the fourth growing module). Then, plants 125 may be transported to any downstream harvesting processes outside of plant cultivation system 100, 200.

Referring still to FIG. 19 and FIG. 20A through FIG. 20E, while and method 300 is described hereinabove with reference to processing one “batch” of plants 125 only through one plant cultivation system 100, 200, let it be noted that method 300 may be executing on multiple “batches” of plants 125 simultaneously within one plant cultivation system 100, 200, as shown, for example, in FIG. 15 and FIG. 16. For example, a different “batch” of plants 125 is being processed at each module and the batches may be progressing, for example, every two weeks through the process. For example, a batch1 of plants 125 may have reached and is being processed at growing module 115d (i.e., the fourth growing module). At the same time, a batch2 of plants 125 may have reached and is being processed at growing module 115c (i.e., the third growing module). At the same time, a batch3 of plants 125 may have reached and is being processed at growing module 115b (i.e., the second growing module). At the same time, a batch4 of plants 125 may have reached and is being processed at growing module 115a (i.e., the first growing module). At the same time, a batch5 of plants 125 may be placed in and is being processed at vegetation module 110.

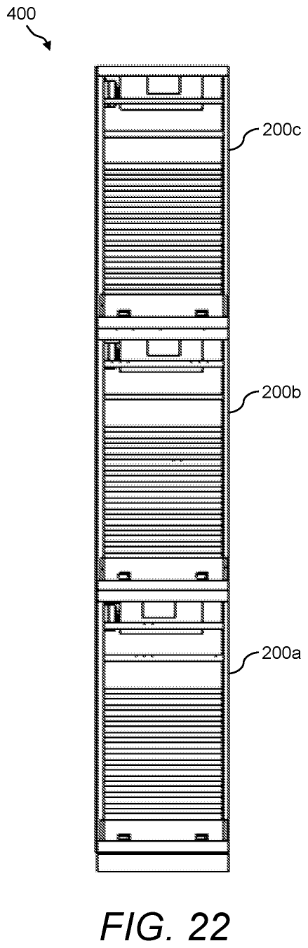

Referring now to FIG. 21 and FIG. 22 is a front view and an end view, respectively, of an example of a stacked configuration 400 of multiple multi-stage plant cultivation systems 200, in accordance with an embodiment of the invention. In this example, stacked configuration 400 may include a stack of three multi-stage plant cultivation systems 200.

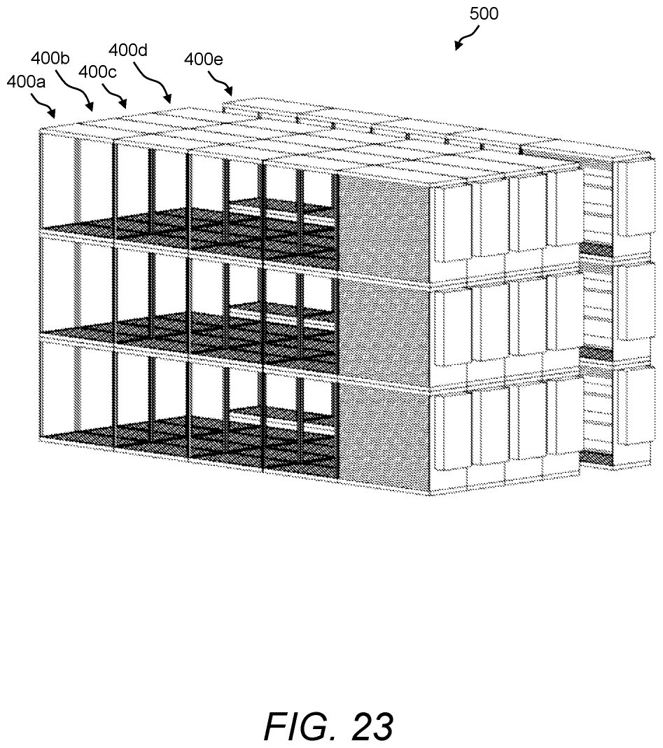

Referring now to FIG. 23 is a perspective view of an example of a configuration 500 of multiple stacked multi-stage plant cultivation systems 200, in accordance with an embodiment of the invention. In this example, configuration 500 may include any arrangement of multiple stacked configurations 400 of plant cultivation systems 200 in a space or room.

Stacked configuration 400 of multiple multi-stage plant cultivation systems 200 and/or configuration 500 of multiple stacked plant cultivation systems 200 allow for high workflow efficiency as compared with current plant cultivation systems and/or processes.

Further, in stacked configuration 400 of multiple multi-stage plant cultivation systems 200 and/or configuration 500, because cultivation density can be stacked, cultivation capacity may be increased within the same area up to 4 times, as compared with current plant cultivation systems and/or processes. For example, using multi-stage plant cultivation systems 200 may minimize access row space and cultivation canopy may be expanded by about 80%.

Further, in stacked configuration 400 of multiple multi-stage plant cultivation systems 200 and/or configuration 500, by increasing cultivation capacity within existing facilities, the need for new construction may be reduces or entirely eliminated. For example, when new construction is necessary, building size and cost may be reduced by up to about 80%. A smaller cultivating area, in turn, may reduce insurance, land acquisition costs, and taxes as compared with current plant cultivation systems and/or processes.

Further, in stacked configuration 400 of multiple multi-stage plant cultivation systems 200 and/or configuration 500, higher density cultivation and consequently smaller cultivation areas also mean less area to heat, illuminate, air condition, and dehumidify and helps to contain workforce to designated areas, as compared with current plant cultivation systems and/or processes.

In summary and referring now again to FIG. 1 through FIG. 23, as compared with current plant cultivation systems and/or processes, the presently disclosed plant cultivation system 100, 200 and method 300 may be used to greatly enhance and accelerate the entire growth process, while minimizing workflow and the energy expenditure required for the entire production process. For example, plant cultivation system 100, 200 and method 300 may be used to combine workflow and cultivation stages for vegetation and flowering cycles into one seamless system, and offers cultivation efficiency that is unique in the field of indoor and outdoor cultivation. For example, the presently disclosed plant cultivation system 100, 200 and method 300 consolidate the workflow components of cultivation into one logical and fluid system.

Further, with respect to cannabis plants the presently disclosed plant cultivation system 100, 200 and method 300 may allow users to micromanage cannabidiol (CBD) and tetrahydrocannabinol (THC) levels for a variety of genetics. Further, any plant that can benefit from enhanced levels of nutrients, flavor, taste, size, or usefulness, by consolidating the vegetative and flowering stages into one fluid system, may benefit from plant cultivation system 100, 200.

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

Throughout this specification and the claims, the terms “comprise,” “comprises,” and “comprising” are used in a non-exclusive sense, except where the context requires otherwise. Likewise, the term “include” and its grammatical variants are intended to be non-limiting, such that recitation of items in a list is not to the exclusion of other like items that can be substituted or added to the listed items.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the subject matter of the present invention. For example, the term “about,” when referring to a value can be meant to encompass variations of, in some embodiments ±100%, in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

Although the foregoing subject matter has been described in some detail by way of illustration and example for purposes of clarity of understanding, it will be understood by those skilled in the art that certain changes and modifications can be practiced within the scope of the appended claims.

That which is claimed:

1. A multi-stage plant cultivation system for enhancing plant production efficiency through the full growing life cycle of a plant, comprising:
a) one or more vegetation modules; and
b) one or more growing modules capable of being tailored with respect to plant growing phases and harvesting;
wherein the vegetation module and the multiple growing modules are arranged sequentially and wherein the full growing life cycle of a plant may be performed within the modules.

2. The multi-stage plant cultivation system of claim 1, wherein the one or more vegetation modules are configured for a germination phase, a seedling phase, and/or a vegetative phase of the plants.

3. The multi-stage plant cultivation system of either claim 1 or claim 2, wherein the one or more growing modules are configured for one or more flowering phases of the plants.

4. The multi-stage plant cultivation system of claim 1, wherein the one or more vegetation modules and the one or more growing modules are arranged sequentially.

5. The multi-stage plant cultivation system of claim 4, comprising the following modules in the following order: a vegetation module, a first growing module, a second growing module, a third growing module, and a fourth growing module.

6. The multi-stage plant cultivation system of claim 5, wherein the first growing module is configured for a first-stage flowering phase of the plants, the second growing module is configured for a second-stage flowering phase of the plants, the third growing module is configured for a third-stage flowering phase of the plants, and the fourth growing module is configured for a fourth-stage flowering phase of the plants.

7. The multi-stage plant cultivation system of any one of claims 1 to 6, further comprising one or more additional components selected from the group consisting of a plant transport system, one or more air handler systems, one or more lighting systems, one or more water delivery systems, one or more wastewater systems, and a controller.

8. The multi-stage plant cultivation system of claim 7, wherein the transport system is capable of automatically translating or moving some number of plants along the multi-stage plant cultivation system.

9. The multi-stage plant cultivation system of claim 8, wherein the transport system is a common transport system for moving plants from one module to another and comprises a conveyor belt system, a gravity-based roller system, a motorized roller system, a gravity-based rail system, or a motorized rail system.

10. The multi-stage plant cultivation system of claim 7, wherein the one or more air handler systems comprise air handler systems for supporting growing environments in the one or more vegetation modules and/or the one or more growing modules.

11. The multi-stage plant cultivation system of claim 10, comprising one or more air handler systems that support the one or more vegetation modules.

12. The multi-stage plant cultivation system of claim 10, comprising one or more air handler systems that support the one or more growing modules.

13. The multi-stage plant cultivation system of claim 7, wherein the one or more lighting systems are suitable for growing plants and comprise light-emitting diodes (LED) white light sources or florescent white light sources.

14. The multi-stage plant cultivation system of claim 13, comprising one or more lighting systems that support the one or more vegetation modules.

15. The multi-stage plant cultivation system of claim 13, comprising one or more lighting systems that support the one or more growing modules.

16. The multi-stage plant cultivation system of claim 7, wherein the one or more water delivery systems are suitable for growing plants and comprise one or more water supply lines, one or more sprinkler heads, one or more spray heads, one or more water spikes, and/or one or more flood systems.

17. The multi-stage plant cultivation system of claim 16, comprising one or more water delivery that support the one or more vegetation modules.

18. The multi-stage plant cultivation system of claim 16, comprising one or more water delivery systems that support the one or more growing modules.

19. The multi-stage plant cultivation system of any one of claims 16 to 18, wherein the one or more water delivery systems comprise a water supply line to each module.

20. The multi-stage plant cultivation system of any one of claims 16 to 18, further comprising individual water storage tanks above each module configured to hold an amount of water that is tailored for each growth stage.

21. The multi-stage plant cultivation system of claim 20, wherein the water further comprises one or more nutrients tailored for each growth stage.

22. The multi-stage plant cultivation system of claim 7, wherein the one or more wastewater removal systems are suitable for growing plants.

23. The multi-stage plant cultivation system of claim 22, comprising one or more wastewater removal systems that support the one or more vegetation modules.

24. The multi-stage plant cultivation system of claim 22, comprising one or more wastewater removal systems that support the one or more growing modules.

25. The multi-stage plant cultivation system of claim 22, comprising one or more wastewater removal systems that support the one or more vegetation modules and the one or more growing modules.

26. The multi-stage plant cultivation system of claim 7, wherein the controller comprises a microcontroller device, a microprocessor device, and/or a computing device.

27. The multi-stage plant cultivation system of claim 26, wherein the controller comprises a centralized server, a cloud server, a desktop computer, a laptop computer, a handheld computing device, a mobile phone or smart phone, a tablet device, and/or a smartwatch.

28. The multi-stage plant cultivation system of either claim 26 or claim 27, further comprising a certain amount of data storage associated with the controller.

29. The multi-stage plant cultivation system of any one of claims 26 to 28, wherein the controller is a networked computing device accessible via a network.

30. The multi-stage plant cultivation system of claim 29, wherein the network comprises a local area network (LAN) and/or a wide area network (WAN) for connecting to the Internet or to an Intranet.

31. The multi-stage plant cultivation system of any one of claims 1 to 30, further comprising granular automation configured to track plant-specific data at each stage via video in order to reduce the human interaction required at each stage, wherein plant-specific data comprises temperature, humidity, soil moisture, plant height, and/or CO₂ levels.

32. The multi-stage plant cultivation system of any one of claims 1 to 31, wherein the plant is a cannabis plant.

33. The multi-stage plant cultivation system of any one of claims 1 to 32, wherein the one or more vegetation modules are configured to provide a controlled environment in which the plants may grow for some period of time.

34. The multi-stage plant cultivation system of claim 33, wherein the period of time is about two weeks.

35. The multi-stage plant cultivation system of any one of claims 1 to 34, wherein the one or more vegetation modules are configured to be controlled with respect to light, airflow, humidity, temperature, water delivery, and/or wastewater removal for the type of plant being grown.

36. The multi-stage plant cultivation system of any one of claims 1 to 35, wherein the one or more growing modules are configured to provide a controlled environment in which the plants may grow for some period of time.

37. The multi-stage plant cultivation system of claim 36, wherein the period of time is about two weeks.

38. The multi-stage plant cultivation system of any one of claims 1 to 37, wherein the one or more growing modules are configured to be controlled with respect to light, airflow, humidity, temperature, water delivery, and/or wastewater removal for the type of plant being grown.

39. The multi-stage plant cultivation system of any one of claims 1 to 38, wherein the one or more vegetation modules and the one or more growing modules are arranged in a line atop an undercarriage.

40. The multi-stage plant cultivation system of claim 39, wherein the undercarriage comprises a roller transport system that spans the full distance of all the modules.

41. The multi-stage plant cultivation system of claim 40, wherein a portion of the roller transport system spans the widths of the one or more vegetation modules.

42. The multi-stage plant cultivation system of claim 40 or claim 41, further comprising one or more grow trays configured to hold plants and sit atop the roller transport system.

43. The multi-stage plant cultivation system of claim 42, wherein the grow trays are further configured to be moved from one module to another by rolling atop the roller transport system.

44. The multi-stage plant cultivation system of any one of claims 39 to 43, wherein the undercarriage is a fixed undercarriage.

45. The multi-stage plant cultivation system of any one of claims 39 to 43, wherein the undercarriage is a mobile undercarriage configured to allow the plant cultivation system to be moved.

46. The multi-stage plant cultivation system of any one of claims 39 to 45, further comprising one or more wastewater drain gutters provided along the undercarriage.

47. The multi-stage plant cultivation system of claim 46, wherein the one or more wastewater drain gutters are configured to channel wastewater to be recycled or disposed of according to water codes.

48. The multi-stage plant cultivation system of any one of claims 39 to 47, further comprising one or more water supply lines provided along the undercarriage configured to supply water to the one or more vegetation modules and/or the one or more growing modules.

49. The multi-stage plant cultivation system of any one of claims 46 to 48, wherein at least a portion of the one or more wastewater drain gutters and one or more water supply lines extend to the one or more vegetation modules via the undercarriage.

50. The multi-stage plant cultivation system of any one of claims 1 to 49, wherein the one or more vegetation modules each comprise a front access door and a side exit door.

51. The multi-stage plant cultivation system of claim 50, wherein the front access door spans substantially the full width and height of the one or more vegetation modules.

52. The multi-stage plant cultivation system of claim 50 or claim 51, wherein the side exit door spans substantially the full depth and partial height of the one or more vegetation modules.

53. The multi-stage plant cultivation system of any one of claims 50 to 52, wherein the front access door and the side exit door comprise rollup type doors suitable to maintain airtight and light-tight conditions within the one or more vegetation modules.

54. The multi-stage plant cultivation system of claim 53, wherein the rollup type doors comprise aluminum or plastic slats configured to slide together to provide a light-tight and airtight seal.

55. The multi-stage plant cultivation system of any one of claims 50 to 54, wherein the front access door and the side exit door further comprise seals comprising a thermoplastic elastomer or polyurethane.

56. The multi-stage plant cultivation system of any one of claims 1 to 55, further comprising one or more grow lights provided inside the one or more vegetation modules.

57. The multi-stage plant cultivation system of claim 56, wherein the one or more grow lights comprise LED lights and/or florescent lights.

58. The multi-stage plant cultivation system of any one of claims 1 to 57, further comprising one or more air handler units provided in the one or more vegetation modules.

59. The multi-stage plant cultivation system of claim 58, wherein the one or more air handler units comprise heating, ventilation, and air conditioning (HVAC) units.

60. The multi-stage plant cultivation system of claim 58 or claim 59, wherein the one or more air handler units are configured to pull in fresh air from the surrounding environment.

61. The multi-stage plant cultivation system of any one of claims 58 to 60, wherein the one or more air handler units comprise a controller.

62. The multi-stage plant cultivation system of any one of claims 1 to 61, wherein at least one of the one or more growing modules comprise a substantially open metal frame structure.

63. The multi-stage plant cultivation system of any one of claims 1 to 61, wherein at least one of the one or more growing modules comprise an enclosed or partially enclosed metal frame structure.

64. The multi-stage plant cultivation system of any one of claims 1 to 65, further comprising one or more grow lights provided inside the one or more growing modules.

65. The multi-stage plant cultivation system of claim 64, wherein the one or more grow lights comprise LED lights and/or florescent lights.

66. The multi-stage plant cultivation system of any one of claims 40 to 65, wherein a portion of the roller transport system spans the widths of the one or more growing modules.

66. The multi-stage plant cultivation system of any one of claims 1 to 65, further comprising one or more air handler units provided in the one or more growing modules.

67. The multi-stage plant cultivation system of claim 66, wherein the one or more air handler units comprise heating, ventilation, and air conditioning (HVAC) units.

68. The multi-stage plant cultivation system of claim 66 or claim 67, wherein the one or more air handler units are configured to pull in fresh air from the surrounding environment.

69. The multi-stage plant cultivation system of any one of claims 66 to 68, wherein the one or more air handler units comprise a controller.

68. The multi-stage plant cultivation system of any one of claims 46 to 67, wherein the roller transport system, the one or more wastewater drain gutters, and the one or more water supply lines each span the entire length of the one or more vegetation modules and the one or more growing modules via the undercarriage.

69. The multi-stage plant cultivation system of any one of claims 42 to 68, wherein the one or more grow trays are further configured to allow for loading and unloading using a forklift.

70. The multi-stage plant cultivation system of any one of claims 40 to 69, wherein the roller transport system comprises an incline.

71. The multi-stage plant cultivation system of any one of claims 38 to 70, configured to allow independent control of each of the one or more vegetation modules and the one or more growing modules with respect to time, light, airflow, humidity, temperature, water delivery, and/or wastewater removal.

72. A method for enhancing plant production efficiency, comprising performing the full growing life cycle of the plant within the modules of the multi-stage plant cultivation system of any one of claims 1 to 71.

73. The method for enhancing plant production efficiency of claim 72, comprising:
i) processing a batch of plants in the one or more vegetation modules for a certain amount of time;
ii) advancing the batch of plants to the one or more growing modules for a certain amount of time; and
iii) removing the batch of plants from the multi-stage plant cultivation system.

74. The method of claim 73, wherein step ii) comprises:
iia) advancing the batch of plants to a first growing module and processing the batch of plants for a certain amount of time;
iib) advancing the batch of plants to a second growing module and processing the batch of plants for a certain amount of time;
iic) advancing the batch of plants to a third growing module and processing the batch of plants for a certain amount of time; and
iid) advancing the batch of plants to a fourth growing module and processing the batch of plants for a certain amount of time.

75. The method of claim 72, comprising:
i) providing the multi-stage plant cultivation system;
ii) activating the multi-stage plant cultivation system;
iii) loading the plants into the one or more vegetation modules;
iv) performing germination, seedling, and/or vegetative growing phases of the plants within the one or more vegetation modules for a certain amount of time;
v) moving the plants out of the one or more vegetation modules and into the one or more growing modules for a certain amount of time; and
vi) removing the batch of plants from the multi-stage plant cultivation system.

76. The method of claim 75, wherein step v) comprises:
va) moving the plants to a first growing module and processing the plants for a certain amount of time;
vb) moving the plants to a second growing module and processing the plants for a certain amount of time;
vc) advancing the plants to a third growing module and processing the plants for a certain amount of time; and
vd) advancing the plants to a fourth growing module and processing the plants for a certain amount of time.

77. The method of any one of claims 73 to 76, wherein after removal of the batch of plants from the multi-stage plant cultivation system, the batch of plants are advanced to downstream harvesting processes.

78. The method of any one of claims 72 to 77, comprising processing multiple batches of plants in different modules simultaneously.

79. The method of any one of claims 72 to 78, wherein the plant is a cannabis plant.

80. The multi-stage plant cultivation system of any one of claims 1 to 71, configured to be stackable.
